(19) United States
(12) Patent Application Publication
(10) Pub. No.: US 2009/0214856 A1
(43) Pub. Date: Aug. 27, 2009

(54) BONDED BODY AND METHOD OF MANUFACTURING BONDED BODY

(75) Inventor: Kazuhiro GOMI, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/388,595

(22) Filed: Feb. 19, 2009

(30) Foreign Application Priority Data
Feb. 22, 2008 (JP) 2008-042205

(51) Int. Cl. B32B 5/16; B29C 65/52; B32B 9/04; B32B 17/00

(52) U.S. Cl. 428/332; 156/60; 428/448; 428/426; 428/447

(57) ABSTRACT

A bonded body having high dimensional accuracy and manufactured easily without problems which occur in the solid bonding method and a method of manufacturing such a bonded body are provided. The bonded body includes a first base member having a first bonding surface; a second base member having a second bonding surface; and a bonding film through which the first base member and the second base member are boded together, the bonding film having two surfaces each making contact with the first bonding surface and the second bonding surface, the bonding film including a silicone portion containing a silicone material composed of silicone compounds and a plurality of gap members that regulate a distance between the first base member and the second base member, at least a part of the gap members provided in the silicone portion. In such a bonded body, energy for bonding is applied to a region of at least a part of the bonding film to develop a bonding property in a vicinity of each of the surfaces of the bonding film corresponding to the region so that the first base member and the second base member are bonded together through the bonding film due to the bonding property.

### CROSS-REFERENCE TO RELATED APPLICATION

This application claims a priority to Japanese Patent Application No. 2008-042205 filed on Feb. 22, 2008 which is hereby expressly incorporated by reference herein in its entirety.

### BACKGROUND

1. Technical Field

The present invention relates to a bonded body in which a first base member and a second base member are bonded together through a bonding film and a method of manufacturing the bonded body.

2. Related Art

Conventionally, when two members (base members) are bonded together to obtain a bonded body, a method, in which the two members are bonded together through an adhesive layer formed of an adhesive such as an epoxy-based adhesive or an urethane-based adhesive, has been often used.

However, in the case where the two members are bonded together using the adhesive layer, there are problems in that dimensional accuracy of the obtained bonded body is low, and it takes a relatively long time until the adhesive is hardened.

On the other hand, as an alternative method of bonding two members without using the adhesive, a solid bonding method of directly bonding the two members together to thereby obtain a bonded body is well known (see, for example, JP-A-5-82404).

However, the solid bonding method has the following problems: (A) constituent materials of the two members to be bonded are limited to specific kinds, (B) a heat treatment using a high temperature (e.g., about 700 to 800° C.) must be performed in the bonding process, (C) an ambient atmosphere in the bonding process is limited to a reduced atmosphere, (D) it is difficult to obtain a state that the two members are partially bonded together, and (E) it is difficult to separate the bonded body into the two members at a desired time, e.g., when the two members are recycled.

### SUMMARY

Accordingly, it is an object of the present invention to provide a bonded body having high dimensional accuracy and manufactured easily without problems which occur in the solid bonding method and a method of manufacturing such a bonded body.

A first aspect of the present invention is directed to a bonded body. The bonded body comprises: a first base member having a first bonding surface; a second base member having a second bonding surface; and a bonding film through which the first base member and the second base member are boded together, the bonding film having two surfaces each making contact with the first bonding surface and the second bonding surface, the bonding film including a silicone portion containing a silicone material composed of silicone compounds and a plurality of gap members that regulate a distance between the first base member and the second base member, at least a part of the gap members provided in the silicone portion.

In the bonded body, energy for bonding is applied to a region of at least a part of the bonding film to develop a bonding property in a vicinity of each of the surfaces of the bonding film corresponding to the region so that the first base member and the second base member are bonded together through the bonding film due to the bonding property.

Such a bonded body has high dimensional accuracy and can be manufactured easily without problems which occur in the solid bonding method.

In the above bonded body, it is preferred that each of the gap members has a particle shape.

In this case, gap members having various particle sizes such as gap members having small particle sizes and gap members having big particle sizes can be easily available. By properly selecting gap members having predetermined particle sizes, the distance between the first base member and the second base member can be set to a desired distance.

In addition, by using the gap members having the small particle sizes, a thickness of the bonding film can be reduced. This makes it possible to further improve the dimensional accuracy of the bonded body.

In the above bonded body, it is preferred that the plurality of the gap members include a plurality of glass fine particles each formed of a glass material as a major component thereof.

Such gap members have relatively high hardness. Therefore, it is possible to regulate the distance between the first base member and the second base member more reliably and correctly.

In the above bonded body, it is preferred that the plurality of the gap members include a plurality of ceramics fine particles each formed of a ceramics material as a major component thereof.

Such gap members have relatively high hardness. Therefore, it is possible to regulate the distance between the first base member and the second base member more reliably and correctly.

In the above bonded body, it is preferred that the plurality of the gap members include a plurality of metal fine particles each formed of a metal material as a major component thereof.

Such gap members have relatively high hardness. Therefore, it is possible to regulate the distance between the first base member and the second base member more reliably and correctly. In addition, the bonding film can have conductivity. This makes it possible to utilize the bonding film or the bonded body as a wiring for electrification.

In the above bonded body, it is preferred that the plurality of the gap members include a plurality of resin fine particles each formed of a resin material as a major component thereof.

Each of such gap members (resin fine particles), in general, has a very high thermal expansion coefficient, whereas the silicone portion containing the silicone material composed of the silicone compounds has a relatively low thermal expansion coefficient. For this reason, a difference between the thermal expansion coefficient of each of the resin fine particles and the thermal expansion coefficient of the silicone portion becomes large.

Therefore, when energy for separation (especially, thermal energy) is applied to the bonding film at a predetermined time, cleavage is positively generated within the bonding film so that the bonded body can be easily and reliably separated into the first base member and the second base member.

In the above bonded body, it is preferred that the plurality of the gap members include a plurality of fine particles composed of at least one kind selected from the group comprising a plurality of glass fine particles each formed of a glass material as a major component thereof, a plurality of ceramics fine particles each formed of a ceramics material as a major component thereof and a plurality of metal fine particles each formed of a metal material as a major component thereof, in addition to the plurality of the resin fine particles, and an average particle size of the plurality of the fine particles is larger than an average particle size of the plurality of the resin fine particles.

This makes it possible to regulate the distance between the first base member and the second base member more reliably and correctly by at least one kind of the glass fine particles, the ceramics fine particles and the metal fine particles.

Further, when the energy for separation (especially, thermal energy) is applied to the bonding film at a predetermined time, the cleavage can be positively generated within the bonding film due to the difference between the thermal expansion coefficient of each of the resin fine particles and the thermal expansion coefficient of the silicone portion.

In the above bonded body, it is preferred that the plurality of the gap members include a plurality of fine particles composed of at least one kind selected from the group comprising a plurality of glass fine particles each formed of a glass material as a major component thereof, a plurality of ceramics fine particles each formed of a ceramics material as a major component thereof and a plurality of metal fine particles each formed of a metal material as a major component thereof, in addition to the plurality of the resin fine particles, an average particle size of the plurality of the fine particles is smaller than an average particle size of the plurality of the resin fine particles, and the resin fine particles exist within the bonding film in a state that at least a part of the resin fine particles is elastically deformed.

This makes it possible to regulate the distance between the first base member and the second base member more reliably and correctly by at least one kind of the glass fine particles, the ceramics fine particles and the metal fine particles.

Further, when the energy for separation (especially, thermal energy) is applied to the bonding film at a predetermined time, the cleavage can be positively generated within the bonding film due to the difference between the thermal expansion coefficient of each of the resin fine particles and the thermal expansion coefficient of the silicone portion.

In addition, a force, by which the resin fine particles elastically deformed are restored in an initial shape, is generated within the bonding film. For this reason, the cleavage can also be positively generated within the bonding film.

In the above bonded body, it is preferred that each of the first bonding surface and the second bonding surface forms a flat surface.

This makes it possible for the gap members to effectively exhibit the function of regulating the distance between the first base member and the second base member.

In the above bonded body, it is preferred that the bonding film is configured so that the bonded body can be separated into the first base member and the second base member by applying energy for separation to the bonding film whereby cleavage is generated within the bonding film due to breakage of a part of molecular bonds of the silicone compounds.

This makes it possible to effectively separate the bonded body into the first base member and the second base member at a desired time, e.g., when they are recycled.

In the above bonded body, it is preferred that the bonding film is configured to generate the cleavage therewithin by at least one method selected from the group comprising a method in which an energy beam is irradiated on the bonding film and a method in which the bonding film is heated.

Such a method can selectively apply the energy for separation to the bonding film relatively easily. This makes it possible to more reliably generate the cleavage within the bonding film.

In the above bonded body, it is preferred that the energy beam is an ultraviolet ray.

Use of the ultraviolet ray makes it possible to reliably generate the cleavage within the bonding film while preventing alteration and deterioration of the first base member and the second base member.

In the above bonded body, it is preferred that at least one of the first base member and the second base member has permeability for the ultraviolet ray.

This makes it possible to effectively irradiate the ultraviolet ray on the bonding film through the first base member and/or the second base member.

In the above bonded body, it is preferred that a temperature of the heating is in the range of 100 to 400° C.

This makes it possible to reliably generate the cleavage within the bonding film while preventing alteration and deterioration of the first base member and the second base member.

In the above bonded body, it is preferred that the bonding film is configured to generate the cleavage therewithin by applying the energy for separation to the bonding film in an air atmosphere.

The air atmosphere contains a sufficient amount of water molecules, and these water molecules penetrate into the bonding film. Therefore, when the molecular bonds of the silicone compounds are broken by applying the energy for separation to the bonding film, and the broken molecular bonds are reacted with the water molecules.

As a result, a gas (e.g., a methane gas) is generated and occupies large volume within the bonding film. In portions where the gas is generated, the bonding film is expanded. At this time, Si—O bonds of the silicone compounds are also broken in these portions, and therefore the cleavage is reliably generated within the bonding film.

In the above bonded body, it is preferred that each of the silicone compounds has a polydimethylsiloxane chemical structure as a main chemical structure thereof.

Such silicone compounds can be preferably used as a major component of the silicone material, because they can be relatively easily available at a low price, and methyl groups included in the polydimethylsiloxane chemical structure can be easily broken and removed therefrom by applying the energy for bonding to the bonding film to thereby reliably develop the bonding property therein.

In the above bonded body, it is preferred that each of the silicone compounds has at least one silanol group.

In this case, when drying the liquid coating to transform it into the bonding film, hydroxyl groups (included in the silanol groups) of the adjacent silicone compounds are bonded together. Therefore, the thus formed bonding film can have more excellent film strength.

In the above bonded body, it is preferred that an average thickness of the bonding film is in the range of 1 to 300 μm.

By setting the average thickness of the bonding film to the above range, the cleavage is reliably generated within the bonding film so that the bonded body can be separated into the first base member and the second base member.

A second aspect of the present invention is directed to a method of manufacturing a bonded body in which a first base member and a second base member are bonded together through a bonding film having a predetermined pattern.

The method comprises: applying a liquid material containing a silicone material composed of silicone compounds and a plurality of gap members onto a surface of at least one of the first base member and the second base member to form a liquid coating having a pattern corresponding to the predetermined pattern of the bonding film on the surface; laminating the first base member and the second base member together through the liquid coating so as to regulate a distance between the first base member and the second base member by the gap members; drying the liquid coating while maintaining the distance between the first base member and the second base member by the gap members to obtain the bonding film having the predetermined pattern; and applying energy for bonding to the bonding film to develop a bonding property in a vicinity of each of surfaces of the bonding film so that the first base member and the second base member are bonded together through the bonding film due to the bonding property.

According to such a method, it is possible to easily manufacture a bonded body having high dimensional accuracy without problems which occur in the solid bonding method.

### BRIEF DESCRIPTION OF THE DRAWINGS

FIG. 1 is a sectional view showing an embodiment of a bonded body according to the present invention.

FIGS. 2A to 2C are sectional views for explaining a method of manufacturing the bonded body (a bonding method) according to the present invention.

FIGS. 3A to 3D are sectional views for explaining the method of manufacturing the bonded body (the bonding method) according to the present invention.

FIGS. 4A to 4C are sectional views for explaining steps of separating the bonded body shown in FIG. 1.

FIG. 5 is an exploded perspective view showing an ink jet type recording head (a liquid droplet ejection head) in which the bonded body according to the present invention is used.

FIG. 6 is a section view illustrating a main portion of the ink jet type recording head shown in FIG. 5.

FIG. 7 is a schematic view showing an embodiment of an ink jet printer equipped with the ink jet type recording head shown in FIG. 5.

FIG. 8 is a longitudinal sectional view schematically showing a preferred embodiment of a transmission screen in which the bonded body according to the present invention is used.

FIG. 9 is a view schematically showing a rear-type projector provided with the transmission screen shown in FIG. 8.

### DESCRIPTION OF EXEMPLARY EMBODIMENTS

Hereinafter, a bonded body and a method of manufacturing the bonded body according to the present invention will be described in detail with reference to preferred embodiments shown in the accompanying drawings.

Bonded Body

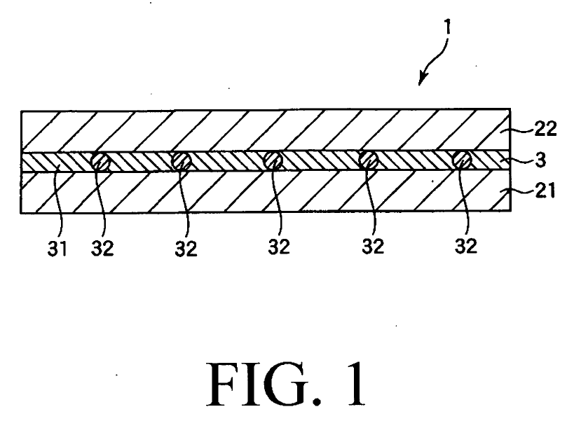

FIG. 1 is a sectional view showing an embodiment of a bonded body according to the present invention.

The bonded body shown in FIG. 1 includes a first base member 21, a second base member 22 and a bonding film 3 interposed between the base members 21 and 22. The first base member 21 and the second base member 22 are bonded together through the bonding film 3.

In this regard, this bonding state of the first base member 21 and the second base member 22 through the bonding film 3 will be referred as the expression “the first base member 21 and the second base member 22 are bonded together” on occasion.

A constituent material of each of the first base member 21 and the second base member 22 is not particularly limited to a specific type. Examples of the constituent material of each of them include: a resin-based material such as polyolefin (e.g., polyethylene, polypropylene, ethylene-propylene copolymer, ethylene-acrylate copolymer, ethylene-acrylic acid copolymer, polybutene-1, ethylene-vinyl acetate copolymer (EVA)), cyclic polyolefin, denatured polyolefin, polyvinyl chloride, polyvinylidene chloride, polystyrene, polyamide, polyimide, polyamide-imide, polycarbonate, poly-(4-methylpentene-1), ionomer, acrylic resin, polymethyl methacrylate (PMMA), acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester (e.g., polyethylene terephthalate (PET), polyethylene naphthalate, polybutylene terephthalate (PBT), polycyclohexane terephthalate (PCT)), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, aromatic polyester (e.g., liquid crystal polymer), fluoro resin (e.g., polytetrafluoroethylene, polyfluorovinylidene), thermoplastic elastomer (e.g., styrene-based elastomer, polyolefin-based elastomer, polyvinylchloride-based elastomer, polyurethane-based elastomer, polyester-based elastomer, polyamide-based elastomer, polybutadiene-based elastomer, trans-polyisoprene-based elastomer, fluororubber-based elastomer, chlorinated polyethylene-based elastomer), epoxy resin, phenolic resin, urea resin, melamine resin, aramid resin, unsaturated polyester, silicone resin, polyurethane, or a copolymer, a blended body and a polymer alloy each having at least one of these materials as a major component thereof; a metal-based material such as a metal (e.g., Fe, Ni, Co, Cr, Mn, Zn, Pt, Au, Ag, Cu, Pd, Al, W, Ti, V, Mo, Nb, Zr, Pr, Nd, Sm), an alloy containing at least one of these metals, carbon steel, stainless steel, indium tin oxide (ITO) or gallium arsenide; a silicon-based material such as monocrystalline silicon, polycrystalline silicon or amorphous silicon; a glass-based material such as silicic acid glass (quartz glass), silicic acid alkali glass, soda lime glass, potash lime glass, lead (alkaline) glass, barium glass or borosilicate glass; a ceramics-based material such as alumina, zirconia, MgAl₂O₄, ferrite, silicon nitride, aluminum nitride, boron nitride, titanium nitride, carbon silicon, boron carbide, titanium carbide or tungsten carbide; a carbon-based material such as graphite; a complex material containing any one kind of the above materials or two or more kinds of the above materials; and the like.

Here, in the case where irradiation of an ultraviolet ray is used as a method of applying energy for bonding or energy for separation, it is preferred that at least one of the first base member 21 and the second base member 22 has permeability for the ultraviolet ray. This makes it possible to effectively irradiate the ultraviolet ray on the bonding film 3 through the first base member 21 and/or the second base member 22.

The constituent materials of the first base member 21 and the second base member 22 may be the same or different from each other. In the case where the constituent materials of the base members 21 and 22 are different from each other, by using a separating method which will be described below, it is possible to easily subject the base members 21 and 22 to a recycle. Therefore, the bonded body 1 has an excellent recycle property.

The bonding film 3 are interposed between the first base member 21 and the second base member 22, and bonds the first base member 21 and the second base member 22 together therethrough.

The bonding film 3 includes a silicone portion 31 formed of a silicone material composed of silicone compounds as a major component thereof. The bonding film 3 further includes a plurality of gap members 32 each having a function of regulating a distance between the first member 21 and the second member 22.

In this embodiment, the plurality of the gap members 32 are scattered and the silicone portion 31 is provided so as to fill spaces between the gap members 32.

The energy for bonding which will be described below is applied to a region of at least a part of such a bonding film 3 to develop a bonding property in a vicinity of each of the surfaces 33 and 34 of the bonding film 3 corresponding to the region. As a result, the first member 21 and the second member 22 are bonded together through the bonding film 3 due to the bonding property.

Especially, since the bonding film 3 includes the plurality of the gap members 32 as described above, the distance between the first member 21 and the second member 22 (that is, a thickness of the bonding film 3) can be uniformized. As a result, it is possible to improve dimensional accuracy of the bonded body 1.

As described in detail below, such a bonded body 1 can be manufactured easily without problems which occur in the solid bonding method. In this regard, it is to be noted that a detail structure of the bonding film 3 will be described in the following method of manufacturing the bonded body 1.

Method of Manufacturing Bonded Body

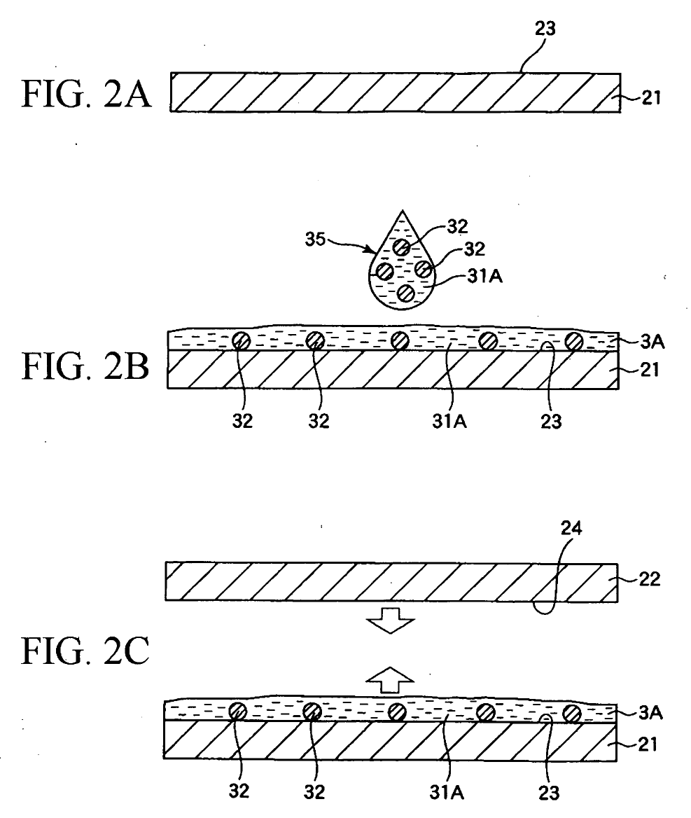

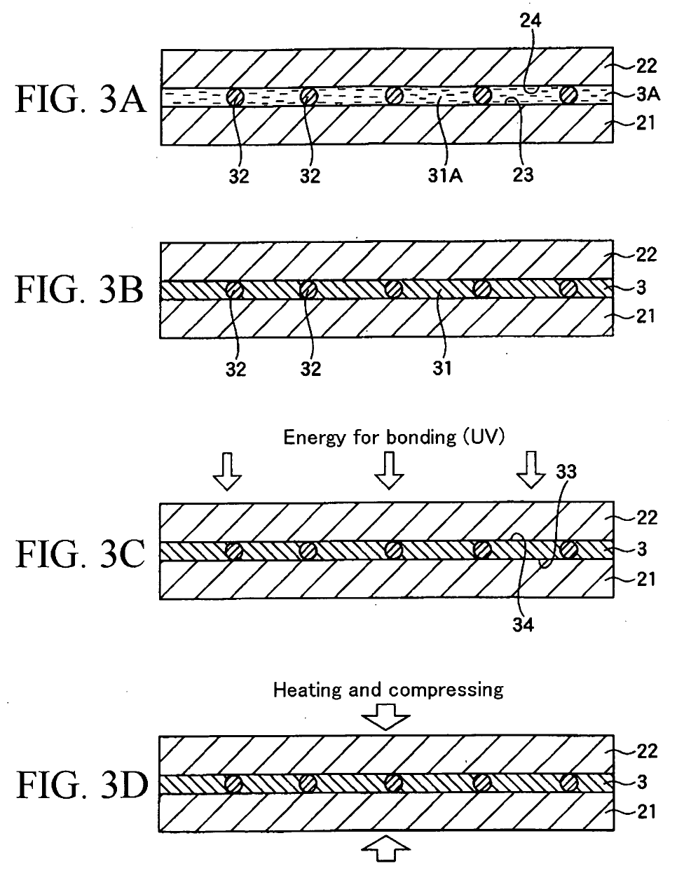

FIGS. 2A to 2C and 3A to 3D are sectional views for explaining a method of manufacturing the bonded body (a bonding method) according to the present invention. In this regard, it is to be noted that in the following description, an upper side in each of FIGS. 2A to 2C and 3A to 3D will be referred to as “upper” and a lower side thereof will be referred to as “lower”.

The method of manufacturing the bonded body 1 having the above structure (that is, the bonding method) comprises the steps of: [A] applying a liquid material containing the silicone material and the gap members 32 onto at least one of the first base member 21 and the second base member 22 to form a liquid coating 3A; [B] laminating the first base member 21 and the second base member 22 together through the liquid coating 3A; [C] drying the liquid coating 3A to obtain the bonding film 3; and [D] applying the energy for bonding to the bonding film 3 to develop the bonding property in the vicinity of each of surfaces 33 and 34 of the bonding film 3 so that the first base member 21 and the second base member 22 are bonded together through the bonding film 3 due to the bonding property.

Hereinafter, the respective steps of the method of manufacturing the bonded body 1 will be specifically described one after another.

[A] Formation of Liquid Coating 3A

-A1—First, the first base member 21 and the second base member 22 each described above are prepared. In this regard, it is to be noted that the second base member 22 is not shown in FIG. 2A.

Here, each of a bonding surface (a first bonding surface) 23 of the first base member 21 and a bonding surface (a second bonding surface) 24 of the second base member 22 forms a flat surface.

This makes it possible for the gap members 32 to effectively exhibit the function of regulating the distance between the first base member 21 and the second base member 22 in the steps [B] and [C] which will be described below. As a result, it is possible to improve the dimensional accuracy of the obtained bonded body 1.

In this regard, it is to be noted that each of the bonding surface 23 of the first base member 21 and the bonding surface 24 of the second base member 22 may have a plurality of fine concave portions like a substrate with concave portions 103 and a substrate with concave portions 104 of a transmission screen 100 which will be described below, as long as each of them macroscopically forms the flat surface.

Surfaces of the first base member 21 and the second base member 22 may be subjected to a plating treatment such as a Ni plating treatment, a passivation treatment such as a chromate treatment, a nitriding treatment, or the like.

Although the constituent material of the first base member 21 may be different from or the same as that of the second base member 22, it is preferred that the first base member 21 and the second base member 22 have substantially equal thermal expansion coefficients with each other.

In the case where the first base member 21 and the second base member 22 have the substantially equal thermal expansion coefficients with each other, when the first base member 21 and the second base member 22 are bonded together, stress due to thermal expansion is less easily generated on bonding interfaces between the first and second base members 21 and 22 and the bonding film 3 (hereinafter, simply referred to as “bonding interfaces” on occasion). As a result, it is possible to reliably prevent occurrence of peeling in the bonded body 1 finally obtained.

As described in detail below, even if the first base member 21 and the second base member 22 have the different thermal expansion coefficients with each other, by optimizing conditions for bonding between the first base member 21 and the second base member 22 in the step which will be described below, they can be firmly bonded together with high dimensional accuracy.

Furthermore, rigidity of the first base member 21 may be different from or the same as that of the second base member 22, it is preferred that the two base members 21 and 22 have different rigidities. This makes it possible to improve adhesion between the two base members 21 and 22 and the bonding film 3, and to thereby more firmly bond them together through the bonding film 3, while improving rigidity of the entire of the bonded body 1.

Moreover, it is preferred that at least one of the two base members 21 and 22 is composed of a resin material. The base member composed of the resin material can be easily deformed due to plasticity of the resin material itself.

Therefore, it is possible to reduce stress which would be generated on the bonding interfaces (e.g., stress due to thermal expansion thereof) when they are bonded together. As a result, breakage of the bonding interfaces becomes difficult to occur. This makes it possible to obtain a bonded body 1 having high bonding strength between the first base member 21 and the second base member 22.

From the above viewpoint, it is preferred that at least one of the two base members 21 and 22 has flexibility. This makes it possible to further improve the bonding strength between the first base member 21 and the second base member 22 in the bonded body 1.

In addition, in the case where the two base members 21 and 22 have flexibility, it is possible to obtain a bonded body 1 having flexibility as a whole thereof. Therefore, such a bonded body 1 can have high functionality.

Further, a shape of each of the base members 21 and 22 may be a plate shape (a film shape), a massive shape (a blocky shape), a stick shape, or the like, as long as it has a shape with a surface which can support the bonding film 3.

In this embodiment, as shown in FIGS. 2A to 2C and 3A to 3D, since the base members 21 and 22 have the plate shape, respectively, they can easily be bent. Therefore, one of the base members 21 and 22 can be sufficiently bent (deformed) according to a shape of the other base member when they are laminated together through the liquid coating 3A.

This makes it possible to improve adhesion between the two base members 21 and 22 and the liquid coating 3A, and to thereby enhance the bonding strength between the first base member 21 and the second base member 22 in the finally obtained bonded body 1.

In addition, since the two base members 21 and 22 can be easily bent, stress which would be generated on the bonding interfaces can be reduced to some extent. In this case, an average thickness of each of the base members 21 and 22 is not particularly limited to a specific value, but is preferably in the range of about 0.01 to 10 mm, and more preferably in the range of about 0.1 to 3 mm.

A bonding surface 23 of the prepared first base member 21 is subjected to a surface treatment for improving the bonding strength between the first base member 21 and the bonding film 3 to be formed, if needed.

By doing so, since the bonding surface 23 of the first base member 21 is cleaned and activated, the bonding film 3 can chemically affect the bonding surface 23 of the first base member 21 easily. As a result, when the bonding film 3 is obtained in the step described below, it is possible to improve the bonding strength between the first base member 21 (the bonding surface 23) and the bonding film 3.

Such a surface treatment is not particularly limited to a specific type. Examples of the surface treatment include: a physical surface treatment such as a sputtering treatment or a blast treatment; a chemical surface treatment such as a plasma treatment performed using oxygen plasma and nitrogen plasma, a corona discharge treatment, an etching treatment, an electron beam irradiation treatment, an ultraviolet ray irradiation treatment or an ozone exposure treatment; a treatment performed by combining two or more kinds of these surface treatments; and the like.

In this regard, it is to be noted that in the case where the first base member 21 to be subjected to the surface treatment is formed of a resin material (a polymeric material), the corona discharge treatment, the nitrogen plasma treatment and the like are particularly preferably used.

Especially, by carrying out the plasma treatment or the ultraviolet ray irradiation treatment as the surface treatment, it is possible to more reliably clean and activate the bonding surface 23 of the first base member 21. As a result, the bonding strength between the first base member 21 and the bonding film 3 can be especially improved.

Depending on the constituent material of the first base member 21, the bonding strength of the bonding film 3 to the first base member 21 becomes sufficiently high even if the bonding surface 23 of the first base member 21 is not subjected to the surface treatment described above.

Examples of the constituent material of the first base member 21 with which such an effect is obtained include materials containing various kinds of the metal-based material, various kinds of the silicon-based material, various kinds of the glass-based material and the like as a major component thereof.

The surface of the first base member 21 formed of such materials is covered with an oxide film. In the oxide film, hydroxyl groups exist in a surface thereof. Therefore, by using the first base member 21 covered with such an oxide film, it is possible to improve the bonding strength between the first base member 21 and the bonding film 3 without subjecting the bonding surface 23 of the first base member 21 to the surface treatment described above.

Like the first base member 21, the bonding surface 24 (that is, a surface which makes contact with the bonding film 3 in the step described below) of the second base member 22 may have been, in advance, subjected to a surface treatment for improving the bonding strength between the second base member 22 (the bonding surface 24) and the bonding film 3, if needed.

By doing so, the bonding surface 24 is cleaned and activated. As a result, when the first base member 21 and the second base member 22 are laminated and bonded together through the bonding film 3, it is possible to improve the bonding strength between the second base member 22 and the bonding film 3.

Such a surface treatment is not particularly limited to a specific type, but the same surface treatment as the above mentioned surface treatment, to which the bonding surface 23 of the first base member 21 is subjected, can be used.

Further, like the first base member 21, depending on the constituent material of the second base member 22, the bonding strength between the second base member 22 and the bonding film 3 becomes sufficiently high even if the bonding surface 24 of the second base member 22 is not subjected to the above surface treatment.

Examples of the constituent material of the second base member 22 with which such an effect is obtained include the above mentioned materials containing the various kinds of the metal-based material, the various kinds of the silicon-based material, the various kinds of the glass-based material and the like as the main material thereof.

The surface of the second base member 22 formed of such materials is covered with an oxide film. In the oxide film, hydroxyl groups exist (are exposed) in a surface thereof. Therefore, by using such a second base member 22 covered with the oxide film, it is possible to improve the bonding strength between the second base member 22 and the bonding film 3 without subjecting the bonding surface 24 of the second base member 22 to the surface treatment described above.

In this regard, it is to be noted that in this case, the entire of the second base member 22 may not be composed of the above materials, as long as the vicinity of the bonding surface 24 of the second base member 22 at least within a region, to which the bonding film 3 is to be bonded, is composed of the above materials.

Furthermore, if the bonding surface 24 of the second base member 22 has the following groups and substances, the bonding strength between the second base member 22 and the bonding film 3 can become sufficiently high even if the bonding surface 24 of the second base member 22 is not subjected to the surface treatment described above.

Examples of such groups and substances include at least one group or substance selected from the group comprising various kinds of functional groups such as a hydroxyl group, a thiol group, a carboxyl group, an amino group, a nitro group and an imidazole group, various kinds of radicals, leaving intermediate molecules such as an open circular molecule and a molecule having at least one unsaturated (double or triple) bond, halogen such as F, Cl, Br or I, and peroxides, and dangling bonds (or uncoupled bonds) generated by leaving the above groups from atoms to which they had been bonded (that is, dangling bonds present in the atoms not terminated by leaving the above groups therefrom).

Among the leaving intermediate molecules, hydrocarbon molecules each including the open circular molecule or the unsaturated bond are preferably selected. Such hydrocarbon molecules affect the bonding film 3 based on marked reactivity thereof. Therefore, in the case where the bonding surface 24 of the second base member 22 has such hydrocarbon molecules, the second base member 22 can be particularly firmly bonded to the bonding film 3.

Further, among the functional groups, the hydroxyl group is preferably selected. In the case where the bonding surface 24 of the second base member 22 has a plurality of the hydroxyl groups, it becomes possible for the second base member 22 (the bonding surface 24) to firmly bond to the bonding film 3 with ease.

Especially, in the case where the hydroxyl groups are exposed on the surface of the bonding film 3, the second base member 22 and the bonding film 3 can be firmly bonded together for a short period of time based on hydrogen bonds which would be generated between the hydroxyl groups of the bonding surface 24 and the hydroxyl groups of the surface.

By appropriately performing one selected from various surface treatment described above, the bonding surface 24 having such groups and substances can be obtained. This makes it possible to obtain a second base member 22 that can be firmly bonded to the bonding film 3.

Among them, it is preferred that the hydroxyl groups exist on the bonding surface 24 of the second base member 22. The second base member 22 having such a bonding surface 24 and the bonding film 3 strongly attract with each other based on hydrogen bonds which would be generated between the hydroxyl groups existing on the bonding surface 24 and the hydroxyl groups exposing from the bonding film 3. This makes it possible to particularly firmly bond the first base member 21 and the second base member 22.

Further, instead of the surface treatment, a surface layer may have been, in advance, provided on the bonding surface 23 of the first base member 21. This surface layer may have any function.

Such a function is not particularly limited to a specific kind. Examples of the function include: a function of improving the bonding strength of the first base member 21 to the bonding film 3; a cushion property (that is, a buffering function); a function of reducing stress concentration; and the like. By forming the bonding film 3 on such a surface layer, a bonded body 1 having high reliability can be obtained finally.

A constituent material of the surface layer include: a metal-based material such as aluminum or titanium; an oxide-based material such as metal oxide or silicon oxide; a nitride-based material such as metal nitride or silicon nitride; a carbon-based material such as graphite or diamond-like carbon; a self-organization film material such as a silane coupling agent, a thiol-based compound, a metal alkoxide or a metal halide compound; a resin-based material such as a resin-based adhesive agent, a resin filming material, a resin coating material, various rubbers or various elastomers; and the like, and one or more of which may be used independently or in combination.

Among the surface layers composed of these various materials, use of the surface layer composed of the oxide-based material makes it possible to further improve the bonding strength between the first base member 21 and the bonding film 3 through the surface layer. Further, like the first base member 21, instead of the surface treatment, a surface layer may have been, in advance, provided on the bonding surface 24 of the second base member 22.

This surface layer may have any function, like in the case of the first base member 21. Such a function is not particularly limited to a specific kind. Examples of the function include: a function of improving the bonding strength of the second base member 22 to the bonding film 3; a cushion property (that is, a buffering function); a function of reducing stress concentration; and the like. By bonding the second base member 22 and the bonding film 3 together through such a surface layer, a bonded body 1 having high reliability can be obtained finally.

As for a constituent material of such a surface layer, for example, the same material as the constituent material of the surface layer to be formed on the bonding surface 23 of the first base member 21 can be used.

In this regard, it is to be noted that such a surface treatment and formation of the surface layer may be carried out, if necessary. For example, in the case where high bonding strength between the first base member 21 and the second base member 22 are not required, the surface treatments and formation of the surface layers can be omitted.

-A2—Next, the liquid material containing the silicone material and the plurality of the gap members 32 (more specifically, a dispersion liquid in which the plurality of the gap members 32 are dispersed in a liquid 31A containing the silicone material) is applied onto the bonding surface 23 of the first base member 21 using an application method. This makes it possible to form the liquid coating 30 on the bonding surface 23 (see, FIG. 2B).

The application method is not particularly limited to a specific type. Examples of the application method include a spin coating method, a casting method, a micro-gravure coating method, a gravure coating method, a bar coating method, a roll coating method, a wire-bar coating method, a dip coating method, a spray coating method, a screen printing method, a flexographic printing method, an offset printing method, a micro-contact printing method, a liquid droplet ejecting method and the like. Among them, it is particularly preferred that the liquid droplet ejecting method is used.

In this embodiment, as shown in FIG. 2B, the liquid droplet ejecting method is used, the liquid material is applied onto the bonding surface 23 in the form of liquid droplets 35. Therefore, even in the case where a liquid coating 3A having a predetermined pattern is selectively formed on a partial region of the bonding surface 23, the liquid material can be reliably applied onto the partial region of the bonding surface 23 corresponding to the predetermined pattern of the liquid coating 30.

Although the liquid droplet ejecting method is not particularly limited to a specific type, it is preferable to use an ink jet method in a type (a piezo-type) that the liquid material is ejected by utilizing vibration of a piezoelectric element. Since in the case where the piezo-type ink jet method is used, heat is not applied to the liquid material, it is advantage that adverse affect with respect to composition thereof and the like can be prevented.

Therefore, alteration (undesired change of a property) of the liquid material is prevented. This makes it possible for the bonding film 3 to reliably and firmly bond the first base member 21 and the second base member 22 together in the step described below.

In this regard, as the liquid droplet ejecting method, well known techniques such as an ink jet method in a type that a liquid material is ejected using bubbles generated by heating it and an ink jet method in a type that the liquid material is ejected by utilizing vibration of an electrostatic actuator, in addition to the piezo-type ink jet method.

A viscosity (at 25° C.) of the liquid material is, generally, preferably in the range of about 0.5 to 200 mPa·s, and more preferably in the range of about 3 to 20 mPa·s. By adjusting the viscosity of the liquid material to the range noted above, the ejection of the liquid droplets 35 can be more stably performed.

Further, the adjustment of the viscosity of the liquid material makes it possible to correctly eject liquid droplets 35 each having a size capable of forming a bonding film 3 having a fine pattern on a region whose shape corresponds to the fine pattern of the bonding film 3.

In addition, such a liquid material can contain a sufficient amount of the silicone material therein. Therefore, by drying the liquid coating 3A formed of such a liquid material in the subsequent step [C], the bonding film 3 can be formed reliably.

Further, in the case where the viscosity of the liquid material is set to the range noted above, an average amount of the liquid droplets 35 (of the liquid material) can be adjusted, specifically to the range of about 0.1 to 40 pL, and more realistically to the range of about 1 to 30 pL.

This makes it possible for a diameter of each of the liquid droplets 35 landed on the bonding surface 23 to become small. Therefore, it is possible to reliably form a bonding film 3 having a just fine pattern (shape).

Furthermore, by appropriately controlling the number of the liquid droplets 35 (the amount of the liquid material) to be applied onto the bonding surface 23, it is possible to relatively easily adjust a thickness of the bonding film 3 to be formed.

As described above, although the liquid material contains the silicone material and the gap members 32, in the case where the silicone material itself is in the form of liquid and the silicone material in which the gap members 32 are dispersed has a desired viscosity range, the silicone material itself can be used as the liquid 31A. In this case, the above liquid material can be obtained by merely dispersing the gap members 32 into the silicone material.

On the other hand, in the case where the silicone material itself is in the form of solid or liquid having a high viscosity, a solution or dispersion liquid containing the silicone material can be used as the liquid 31A. The liquid material can be obtained by dispersing the gap members 32 into the liquid 31A.

Examples of a solvent dissolving the silicone material or a dispersion medium for dispersing the same include: various kinds of inorganic solvents such as ammonia, water, hydrogen peroxide, carbon tetrachloride and ethylene carbonate; various kinds of organic solvents such as ketone-based solvents (e.g., methyl ethyl ketone (MEK) and acetone), alcohol-based solvents (e.g., methanol, ethanol and isopropanol), ether-based solvents (e.g., diethyl ether and diisopropyl ether), cellosolve-based solvents (e.g., methyl cellosolve), aliphatic hydrocarbon-based solvents (e.g., hexane and pentane), aromatic hydrocarbon-based solvents (e.g., toluene, xylene and benzene), aromatic heterocycle compound-based solvents (e.g., pyridine, pyrazine and furan), amide-based solvents (e.g., N,N-dimethylformamide), halogen compound-based solvents (dichloroethane and chloroform), ester-based solvents (e.g., ethyl acetate and methyl acetate), sulfur compound-based solvents (e.g., dimethyl sulfoxide (DMSO) and sulfolane), nitrile-based solvents (e.g., acetonitrile, propionitrile and acrylonitrile), organic acid-based solvents (e.g., formic acid and trifluoroacetic acid); mixture solvents each containing at least one kind of the above solvents; and the like.

The silicone material is contained in the liquid material and is a main constituent material of the bonding film 3 which will be formed by drying the liquid material in the subsequent step [C].

Here, “silicone material” means a material composed of silicone compounds (molecules) each having a polyorganosiloxane chemical structure, that is, silicone compounds each having a main chemical structure (a main chain) mainly constituted of organosiloxane repeating units.

Each of the silicone compounds contained in the silicone material may have a branched chemical structure including the main chain and side chains each branched therefrom, a ringed chemical structure in which the main chain forms a ring shape, or a straight chemical structure in which both ends of the main chain are not bonded together.

In each silicone compound having the polyorganosiloxane chemical structure, for example, an organosiloxane repeating unit constituting each end portion of the polyorganosiloxane chemical structure is a repeating unit represented by the following general formula (1), an organosiloxane repeating unit constituting each connecting portion of the polyorganosiloxane chemical structure is a repeating unit represented by the following general formula (2), and an organosiloxane repeating unit constituting each branched portion of the polyorganosiloxane chemical structure is a repeating unit represented by the following general formula (3).

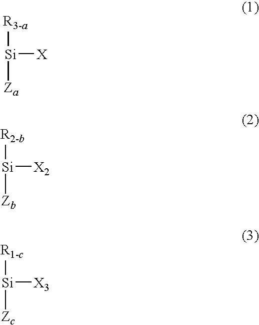

wherein in the general formulas (1) to (3), each of the Rs i s independently a substituted hydrocarbon group or an unsubstituted hydrocarbon group, each of the Zs is independently a hydroxyl group or a hydrolysable group, each of the Xs is a siloxane residue, the a is 0 or an integer of 1 to 3, the b is 0 or an integer of 1 to 2, and the c is 0 or 1.

In this regard, the siloxane residue means a substituent group which is bonded to a silicon atom contained in an adjacent repeating unit via an oxygen atom to thereby form a siloxane bond. Specifically, the siloxane residue is a chemical structure of —O—(Si), wherein the Si is the silicon atom contained in the adjacent repeating unit.

In each silicone compound, the polyorganosiloxane chemical structure is preferably the straight chemical structure, that is, a chemical structure constituted of the repeating units each represented by the above general formula (1) and the repeating units each represented by the above general formula (2).

In the case where a silicone material composed of such silicone compounds is used, since in the subsequent step [C], the silicone compounds are tangled together in the liquid material (the liquid coating 3A) so that the bonding film 3 is formed, the thus formed bonding film 3 can have excellent film strength.

Specifically, examples of the silicone compound having such a polyorganosiloxane chemical structure include a silicone compound represented by the following general formula (4).

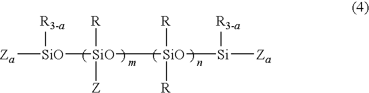

Wherein in the general formula (4), each of the Rs is independently a substituted hydrocarbon group or an unsubstituted hydrocarbon group, each of the Zs is independently a hydroxyl group or a hydrolysable group, the a is 0 or an integer of 1 to 3, the m is 0 or an integer of 1 or more, and the n is 0 or an integer of 1 or more.

In the general formulas (1) to (4), examples of the R (the substituted hydrocarbon group or unsubstituted hydrocarbon group) include: an alkyl group such as a methyl group, an ethyl group or a propyl group; a cycloalkyl group such as a cyclopentyl group or a cyclohexyl group; an aryl group such as a phenyl group, a tolyl group or a biphenylyl group; and an aralkyl group such as a benzyl group or a phenyl ethyl group.

Further, in the above groups, a part of or all of hydrogen atoms bonding to carbon atom(s) may be respectively substituted by I) a halogen atom such as a fluorine atom, a chlorine atom or a bromine atom, II) an epoxy group such as a glycidoxy group, III) a (meth)acryloyl group such as an methacryl group, IV) an anionic group such as a carboxyl group or a sulfonyl group, and the like.

Examples of the hydrolysable group include: an alkoxy group such as a methoxy group, an ethoxy group, a propoxy group, a butoxy group; a ketoxime group such as a dimethyl ketoxime group or a methyl ethyl ketoxime group; an acyloxy group such as an acetoxy group; an alkenyloxy group such as an isopropenyloxy group or an isobutenyloxy group; and the like.

Further, in the general formula (4), the m and n represent a degree of polymerization of the polyorganosiloxane chemical structure. The total number of the m and n (that is, m+n) is preferably an integer of about 5 to 10,000, and more preferably an integer of about 50 to 1,000. By setting the degree of the polymerization to the above range, the viscosity of the liquid material can be adjusted to the above mentioned range relatively easily.

Among various kinds of the silicone materials, it is preferable to use a silicone material composed of silicone compounds each having a polydimethylsiloxane chemical structure (that is, a chemical structure represented by the above general formula (4) in which the Rs are the methyl groups) as a main chemical structure thereof. Such silicone compounds can be relatively easily available at a low price.

Further, such silicone compounds can be preferably used as a major component of the silicone material because the methyl groups are easily broken and removed therefrom by applying the energy for bonding. Therefore, in the case where the bonding film 3 contains such a silicone material, when applying the energy for bonding to the bonding film 3 in the subsequent step [D], it is possible for the bonding film 3 (the silicone portion 31) to reliably develop the bonding property.

In addition, it is preferred that each of the silicone compounds has a t least on e silanol group. Specifically, it is preferable to use silicone compounds each having a chemical structure represented by the above general formula (4) in which the Zs are the hydroxyl groups.

In the case where the bonding film 3 is formed using the silicone material composed of such silicone compounds, when drying the liquid coating 30 to transform it into the bonding film 3 in the subsequent step [C], the hydroxyl groups (included in the silanol groups) of the adjacent silicone compounds are bonded together. Therefore, the thus formed bonding film 3 can have more excellent film strength.

In addition, in the case where the first base member 21 described above, in which the hydroxyl groups are exposed on the bonding surface 23, is used, the hydroxyl groups (included in the silanol groups) of the silicone compounds and the hydroxyl groups present in the first base member 21 are bonded together.

As a result, the silicone compounds can be bonded to the bonding surface 23 not only through physical bonds but also through chemical bonds. This makes it possible for the bonding film 3 to be firmly bonded to the first base member 21 (the bonding surface 23).

Further, the silicone material is a material having relatively high flexibility. Therefore, even if the constituent material of the first base member 21 is different from that of the second base member 22, when the bonded body 1 is obtained by bonding them together through the bonding film 3 in the subsequent step [D], the bonding film 3 can reliably reduce stress which would be generated between the first and second base members 21 and 22 due to thermal expansions thereof. As a result, it is possible to reliably prevent occurrence of peeling in the bonded body 1 finally obtained.

Since the silicone material also has excellent chemical resistance, it can be effectively used in bonding members, which are exposed to chemicals for a long period of time, together. Specifically, for example, the bonding film 3 of the present invention can be used in manufacturing a liquid droplet ejection head of a commercial ink jet printer in which an organic ink being apt to erode a resin material is employed. This makes it possible to reliably improve durability of the liquid droplet ejection head.

In addition, since the silicone material has excellent heat resistance, it can also be effectively used in bonding members, which are exposed to a high temperature, together.

The gap members 32 are provided so as to make contact with both the bonding surface 23 of the first base member 21 and the bonding surface 24 of the second base member 22. By such a construction, an average distance between the first base member 21 and the second base member 22 is regulated so as to become identical with an average particle size of the plurality of the gap members 32.

In this embodiment, each of the gap members 32 has a particle shape. In this case, gap members 32 having various particle sizes such as gap members 32 having small particle sizes and gap members 32 having big particle sizes can be easily available. By properly selecting gap members 32 having predetermined particle sizes, the distance between the first base member 21 and the second base member 22 can be set to a desired distance.

In addition, by using the gap members 32 having the small particle sizes, a thickness of the bonding film 3 can be reduced. This makes it possible to further improve the dimensional accuracy of the bonded body 1.

Further, each of the gap members 32 has a spherical shape. In this regard, the shape of each of the gap members 32 is not limited thereto, but examples of the shape of each of the gap members 32 may include an elliptic spherical shape, a flat shape, an irregular shape, a block shape, and the like.

The average particle size of the plurality of the gap members 32 is not particularly limited to a specific value, but is preferably in the range of about 1 to 300 μm, and more preferably in the range of about 3 to 200 μm.

It is preferred that a standard deviation (a degree of a variation) of the particle sizes of the plurality of the gap members 32 is as small as possible. Specifically, the standard deviation of the particle sizes of the plurality of the gap members 32 is preferably 1.0 μm or less, more preferably 0.8 μm or less, and even more preferably 0.6 μm or less.

Further, a constituent material of each of the gap members 32 is not particularly limited to a specific type. Examples of the constituent material of each of the gap members 32 include: a silicon material such as monocrystalline silicon, polycrystalline silicon or amorphous silicon; a metal material such as stainless steel, titanium or aluminum; a glass material such as silicic acid glass (quartz glass), silicic acid alkali glass, soda lime glass, potash lime glass, lead (alkaline) glass, barium glass or borosilicate glass; a ceramics material such as alumina, zirconia, ferrite, silicon nitride, aluminum nitride, boron nitride, titanium nitride, carbon silicon, boron carbide, titanium carbide or tungsten carbide; a carbon material such as graphite; a resin material such as polyolefin (e.g., polyethylene, polypropylene, ethylene-propylene copolymer, ethylene-vinyl acetate copolymer (EVA)), cyclic polyolefin, denatured polyolefin, polyvinyl chloride, polyvinylidene chloride, polystyrene, polyamide, polyimide, polyamide-imide, polycarbonate, poly-(4-methylpentene-1), ionomer, acrylic resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester (e.g., polyethylene terephthalate (PET), polyethylene naphthalate, polybutylene terephthalate (PBT), polycyclohexane terephthalate (PCT) ), polyether, polyether ketone (PEK), polyether ether ketone (PEEK), polyether imide, polyacetal (POM), polyphenylene oxide, denatured polyphenylene oxide, denatured polyphenylene ether resin (PBO), polysulfone, polyether sulfone, polyphenylene sulfide (PPS), polyarylate, aromatic polyester (e.g., liquid crystal polymer), fluoro resin (e.g., polytetrafluoroethylene, polyfluorovinylidene), thermoplastic elastomer (e.g., styrene-based elastomer, polyolefin-based elastomer, polyvinylchloride-based elastomer, polyurethane-based elastomer, polyester-based elastomer, polyamide-based elastomer, polybutadiene-based elastomer, trans-polyisoprene-based elastomer, fluororubber-based elastomer, chlorinated polyethylene-based elastomer), epoxy resin, phenolic resin, urea resin, melamine resin, aramid resin, unsaturated polyester, silicone resin, polyurethane, or a copolymer, a blended body and a polymer alloy each having at least one of these materials as a major component thereof; a complex material containing any one kind of the above materials or two or more kinds of the above materials; and the like.

The constituent material of each of the gap members 32 may be different from or the same as those of the first base member 21 and the second base member 22. In order to effectively achieve the function of regulating the distance between the first base member 21 and the second base member 22, it is preferred that the gap members 32 are as hard as possible.

From the above viewpoint, it is preferred that the plurality of the gap members 32 include a plurality of glass fine particles each formed of the glass material as a major component thereof. Since the glass fine particles have relatively high hardness, it is possible to regulate the distance between the first base member 21 and the second base member 22 more reliably and correctly.

Further, it is preferred that the plurality of the gap members 32 include a plurality of ceramics fine particles each formed of the ceramics material as a major component thereof. Since the ceramics fine particles also have relatively high hardness, the gap members 32 composed of the ceramics fine particles can regulate the distance between the first base member 21 and the second base member 22 more reliably and correctly.

Furthermore, it is preferred that the plurality of the gap members 32 include a plurality of metal fine particles each formed of the metal material as a major component thereof. Since the metal fine particles also have relatively high hardness, the gap members 32 composed of the metal fine particles can regulate the distance between the first base member 21 and the second base member 22 more reliably and correctly.

In addition, in the case where the gap members 32 are composed of the metal fine particles, the bonding film 3 can have conductivity. This makes it possible to utilize the bonding film 3 or the bonded body 1 as a wiring for electrification.

On the other hand, in order to easily separate the bonded body 1 into the first base member 21 and the second base member 22 by applying the energy for separation to the bonding film 3, it is preferred that a difference between a thermal expansion coefficient of each of the gap members 32 and a thermal expansion coefficient of the silicone portion 31 is as large as possible.

From the above viewpoint, it is preferred that the plurality of the gap members 32 include a plurality of resin fine particles each formed of the resin material as a major component thereof. Each of the resin fine particles, in general, has a very high thermal expansion coefficient, whereas the silicone portion 31 has a relatively low thermal expansion coefficient.

For this reason, in the case where the gap members 32 are composed of the resin fine particles, it is possible to make the difference between the thermal expansion coefficient of each of the gap members 32 and the thermal expansion coefficient of the silicone portion 31 large.

Therefore, when the energy for separation (especially, thermal energy) is applied to the bonding film 3 at a predetermined time, cleavage is positively generated within the bonding film 3 so that the bonded body can be easily and reliably separated into the first base member 21 and the second base member 22.

Further, as the plurality of the gap members 32, two or more kinds selected from the group comprising the plurality of the resin fine particles, the plurality of the glass fine particles, the plurality of the ceramics fine particles and the plurality of the metal fine particles can be used in combination.

In such a manner, in the case where various kinds of the fine particles are used in combination, it is preferred that the plurality of the gap members 32 include a plurality of fine particles composed of at least one kind selected from the group comprising the glass fine particles, the ceramics fine particles and the metal fine particles, in addition to the plurality of the resin fine particles.

In this case, it is also preferred that an average particle size of the plurality of the fine particles is larger than an average particle size of the plurality of the resin fine particles.

This makes it possible to regulate the distance between the first base member 21 and the second base member 22 more reliably and correctly by at least one kind of the glass fine particles, the ceramics fine particles and the metal fine particles.

Further, when the energy for separation (especially, the thermal energy) is applied to the bonding film 3 at a predetermined time, the cleavage can be positively generated within the bonding film 3 due to the difference between the thermal expansion coefficient of each of the gap members 32 (the resin fine particles) and the thermal expansion coefficient of the silicone portion 31.

Furthermore, in the case where various kinds of the fine particles are used in combination, it is preferred that the plurality of the gap members 32 include a plurality of fine particles composed of at least one kind selected from the group comprising the glass fine particles, the ceramics fine particles and the metal fine particles, in addition to the plurality of the resin fine particles.

In this case, it is also preferred that an average particle size of the plurality of the fine particles is smaller than an average particle size of the plurality of the resin fine particles, and the resin fine particles exist within the bonding film 3 in a state that at least a part of the resin fine particles is elastically deformed (compressed).

This makes it possible to regulate the distance between the first base member 21 and the second base member 22 more reliably and correctly by at least one kind of the glass fine particles, the ceramics fine particles and the metal fine particles.

Further, when the energy for separation (especially, the thermal energy) is applied to the bonding film 3 at a predetermined time, the cleavage can be positively generated within the bonding film 3 due to the difference between the thermal expansion coefficient of each of the gap members 32 (the resin fine particles) and the thermal expansion coefficient of the silicone portion 31.

In addition, a force, by which the resin fine particles elastically deformed are restored in an initial shape, is generated within the bonding film 3. For this reason, the cleavage also can be positively generated within the bonding film 3.

Lamination of First Base Member 21 and Second Base Member 22

Next, as shown in FIGS. 2C and 3A, the first base member 21 and the second base member 22 are laminated together through the liquid coating 3A. At this time, the first base member 21 and the second base member 22 are compressed in a direction in which they come close to each other. By doing so, the distance between the first base member 21 and the second base member 22 is regulated by the gap members 32 (see FIG. 3A).

In this way, the first base member 21 and the second base member 22 are laminated together through the liquid coating 3A in a state that the distance therebetween is regulated by the gap members 32.

It is preferred that the liquid coating 3A is dried under conditions milder than drying conditions to be employed in the subsequent step [C] between this step [B] and the above step [A], so that the liquid coating 3A becomes a semisolid state or a semihardened state.

This makes it possible to easily carry out the drying of the liquid coating 3A in the subsequent step [C]. Further, this also makes it possible to improve the adhesion between the bonding film 3 and the first and second base members 21 and 22 while effectively achieving the above function of the gap members 32 in this step [B].

In this step [B], the first base member 21 and the second base member 22 are compressed to each other. A compressing pressure is controlled to a pressure by which the first base member 21 and the second base member 22 are not deformed by the gap members 32 (that is, the gap members 32 are not embedded into the first base member 21 and the second base member 22), depending on the constituent materials and hardness of the first base member 21 and the second base member 22 and the like.

[C] Drying of Liquid Coating 3A

Next, by drying the liquid coating 3A, as shown in FIG. 3B, the bonding film 3 is formed. In this way, the first base member 21 and the second base member 22 are provisionally bonded together through the bonding film 3.

A drying temperature of the liquid coating 3A is preferably 25° C. or higher, and more preferably in the range of about 25 to 100° C. Further, a drying time of the liquid coating 3A is preferably in the range of about 0.5 to 48 hours, and more preferably in the range of about 15 to 30 hours.

By drying the liquid coating 3A under the above conditions, it is possible to reliably form a bonding film 3 capable of appropriately developing the bonding property when applying the energy for bonding in the following step [D].

Further, as described in the step [A], in the case where the silicone material composed of the silicone compounds each having the at least one silanol group is used, the hydroxyl groups included in the silanol groups of the silicone compounds are reliably bonded together.

In addition, such hydroxyl groups and the hydroxyl groups present in the first base member 21 and the second base member 22 are reliably bonded together. For these reasons, the thus formed bonding film 3 can have excellent film strength and be firmly bonded to the first base member 21 and the second base member 22.

An ambient pressure in drying the liquid coating 3A may be an atmospheric pressure, but is preferably a reduced pressure. Specifically, a degree of the reduced pressure is preferably in the range of about 133.3×10⁻⁵ to 1,333 Pa (1×10⁻⁵ to 10 Torr), and more preferably in the range of about 133.3×10⁻⁴ to 133.3 Pa (1×10⁻⁴ to 1 Torr).

This makes it possible to increase density of the bonding film 3, that is, the bonding film 3 can become dense. As a result, the bonding film 3 can have more excellent film strength.

In this way, by appropriately controlling the conditions in forming the bonding film 3, it is possible to form a bonding film 3 having a desired film strength and the like.

In this embodiment, an average thickness of the bonding film 3 is substantially identical with the average particle size of the gap members 32. Like the above average particle size of the gap members 32, the average thickness of the bonding film 3 is not particularly limited to specific value, but is preferably in the range of 1 to 300 μm, and more preferably in the range of 3 to 200 μm.

By setting the average thickness of the bonding film 3 to the above range, the cleavage is reliably generated within the bonding film 3 so that the bonded body 1 can be separated into the first base member 21 and the second base member 22 by using a separating method of the bonded body 1 which will be described below.

Further, by setting the average thickness of the bonding film 3 to the above range, the bonding film 3 can have a certain degree of elasticity. Therefore, when the first base member 21 and the second base member 22 are bonded together in the subsequent step [D], the bonding film 3 can be bonded to the first and second base members 21 and 22.

As a result, it is possible to improve the bonding strength between the first base member 21 and the second base member 22 (including the bonding strength between the first base member 21 and the bonding film 3 and the bonding strength between the second base member 22 and the bonding film 3).

[D] Application of Energy for Bonding on Bonding Film 3

Next, as shown in FIG. 3C, the energy for bonding is applied on the bonding film 3.

When the energy for bonding is applied to the bonding film 3, a part of molecular bonds of the silicone compounds present in the vicinity of each of the surfaces 33 and 34 of the bonding film 3 (boundary surfaces between the first and second base members 21 and 22 and the bonding film 3) are broken.

In this regard, for example, if the silicone compounds are the silicone compounds each having the polydimethylsiloxane chemical structure as the main chemical structure thereof, each of the molecular bonds is a Si—CH₃ bond.

As a result, the surfaces 33 and 34 are activated due to breakage of the molecular bonds. Namely, the bonding property with respect to the first base member 21 is developed in the vicinity of the surface 33 of the bonding film 3 and the bonding property with respect to the second base member 22 is developed in the vicinity of the surface 34 of the bonding film 3.

The first base member 21 and the second base member 22 can be firmly bonded to the bonding film 3 based on chemical bonds due to such bonding properties of the bonding film 3.

Here, in this specification, a state that the surfaces 33 and 34 of the bonding film 3 are “activated” means: a state that a part of the molecular bonds of the silicone compounds present in the vicinity of each of the surfaces 33 and 34 are broken as described above, e.g., a part of the methyl groups are broken and removed from the polydimethylsiloxane chemical structure, and a part of the silicon atoms are not terminated so that “dangling bonds (or uncoupled bonds)” are generated on each of the surfaces 33 and 34; a state that the silicon atoms having the dangling bonds (the unpaired electrons) are terminated by hydroxyl groups (OH groups) and the hydroxyl groups exist on each of the surfaces 33 and 34; and a state that the dangling bonds and the hydroxyl groups coexist on each of the surfaces 33 and 34.

The energy for bonding may be applied to the bonding film 3 by any method. Examples of the method include: a method in which an energy beam is irradiated on the bonding film 3; a method in which the bonding film 3 is heated; a method in which a compressive force (physical energy) is applied to the bonding film 3; a method in which the bonding film 3 is exposed to plasma (that is, plasma energy is applied to the bonding film 3); a method in which the bonding film 3 is exposed to an ozone gas (that is, chemical energy is applied to the bonding film 3); and the like, and one or more of which may be used independently or in combination.

Among these methods, in this embodiment, it is particularly preferred that the method in which the energy beam is irradiated on the bonding film 3 is used as the method in which the energy for bonding is applied to the bonding film 3. Since such a method can efficiently apply the energy for bonding to the bonding film 3 relatively easily, the method is suitably used as the method of applying the energy for bonding. This makes it possible to effectively activate each of the surfaces 33 and 34 of the bonding film 3.

According to the method in which the energy beam is irradiated on the bonding film 3, it is possible to prevent excessive breakage of the molecular bonds of the silicone compounds contained in the bonding film 3. Therefore, in the case where the energy for separation is applied to the bonding film 3 when the bonded body is separated, it is possible to reliably generate the cleavage within the bonding film 3.

Examples of the energy beam include: a ray such as an ultraviolet ray or a laser beam; an electromagnetic wave such as a X ray or a γray; a particle beam such as an electron beam or an ion beam; and combinations of two or more kinds of these energy beams.

Among these energy beams, it is particularly preferred that an ultraviolet ray having a wavelength of about 126 to 300 nm is used (see FIG. 3C). Use of the ultraviolet ray having such a wavelength makes it possible to optimize an amount of the energy for bonding to be applied to the bonding film 3.

As a result, it is possible to prevent excessive breakage of the molecular bonds of the silicone compounds contained in the bonding film 3 as the major component thereof, and to selectively break the molecular bonds of the silicone compounds present in the vicinity of each of the surfaces 33 and 34 of the bonding film 3. This makes it possible for the bonding film 3 to develop the bonding property, while preventing a property thereof such as a mechanical property or a chemical property from being lowered.

In this case, at least one of the first base member 21 and the second base member 22 need to have translucency (permeability for the ultraviolet ray). This makes it possible to reliably irradiate the ultraviolet ray on the bonding film 3 from a side of the base member having the translucency (one side or both sides of the bonding film 3).

Further, the use of the ultraviolet ray makes it possible to process a wide area of each of the surfaces 33 and 34 of the bonding film 3 without unevenness in a short period of time. Moreover, such an ultraviolet ray has, for example, an advantage that it can be generated by simple equipment such as an UV lamp.

In this regard, it is to be noted that the wavelength of the ultraviolet ray is more preferably in the range of about 126 to 200 nm.

In the case where the UV lamp is used, power of the UV lamp is preferably in the range about of 1 mW/cm² to 1 W/cm², and more preferably in the range of about 5 to 50 mW/cm², although being different depending on an area of each of the surfaces 33 and 34 of the bonding film 3. In this case, a distance between the UV lamp and the bonding film 3 is preferably in the range of about 3 to 3,000 mm, and more preferably in the range of about 10 to 1,000 mm.

Further, a time for irradiating the ultraviolet ray is preferably set to a time enough for selectively breaking the molecular bonds of the silicone compounds present in the vicinity of each of the surfaces 33 and 34 of the bonding film 3.

Specifically, the time is preferably in the range of about 1 second to 30 minutes, and more preferably in the range of about 1 second to 10 minutes, although being slightly different depending on an amount of the ultraviolet ray, the constituent material of the bonding film 3, and the like. The ultraviolet ray may be irradiated temporally continuously or intermittently (in a pulse-like manner).

Further, the irradiation of the energy beam on the bonding film 3 may be performed in any ambient atmosphere. Specifically, examples of the ambient atmosphere include: an oxidizing gas atmosphere such as air or an oxygen gas; a reducing gas atmosphere such as a hydrogen gas; an inert gas atmosphere such as a nitrogen gas or an argon gas; a decompressed (vacuum) atmospheres obtained by decompressing any one of these ambient atmospheres; and the like.

Among these ambient atmospheres, the irradiation is particularly preferably performed in the inert gas atmosphere or the decompressed atmosphere. This makes it possible to prevent alteration and deterioration of the first base member 21 and the second base member 22 when the energy for bonding is irradiated on the bonding film 3 therethrough as shown in FIG. 3C.

Further, according to the method of irradiating the energy beam, the energy of the bonding can be easily applied to the bonding film 3 selectively. For this reason, it is also possible to prevent the alteration and deterioration of the first base member 21 and the second base member 22 due to the application of the energy for bonding.

Further, according to the method of irradiating the energy beam, magnitude of the energy for bonding to be applied can be accurately and easily controlled. Therefore, it is possible to adjust the number of the molecular bonds to be broken within the bonding film 3. By adjusting the number of the molecular bonds to be broken in this way, it is possible to easily control the bonding strength between the first base member 21 and the second base member 22.

In other words, by increasing the number of the molecular bonds to be broken in the vicinity of each of the surfaces 33 and 34 of the bonding film 3, since a large number of active hands are generated in the vicinity of each of the surfaces 33 and 34, it is possible to further improve the bonding property developed in the bonding film 3.

On the other hand, by reducing the number of the molecular bonds to be broken in the vicinity of each of the surfaces 33 and 34 of the bonding film 3, it is possible to reduce the number of the active hands generated in the vicinity of each of the surfaces 33 and 34, thereby suppressing the bonding property developed in the bonding film 3.

In order to adjust the magnitude of the applied energy for bonding, for example, conditions such as a kind of the energy beam, power of the energy beam, and an irradiation time of the energy beam only have to be controlled.

Further, according to the method of irradiating the energy beam, a large amount of the energy for bonding can be applied to the bonding film 3 for a short period of time. This makes it possible to more effectively perform the application of the energy for bonding.

In this step [D], the bonding property with respect to the first base member 21 is developed in the surface 33 of the bonding film 3 so that the surface 33 of the bonding film 3 and the bonding surface 23 of the first base member 21 are chemically bonded together, and the bonding property with respect to the second base member 22 is developed in the surface 34 of the bonding film 3 so that the surface 34 of the bonding film 3 and the bonding surface 24 of the second base member 22 are chemically bonded together.

As a result, the first base member 21 and the second base member 22 are bonded together through the bonding film 3, to thereby obtain a bonded body 1 shown in FIG. 3C.

In the bonded body 1 obtained in this way, the two base members 21 and 22 are bonded together through the bonding film 3 by firm chemical bonds formed in a short period of time such as a covalent bond, unlike bond (adhesion) mainly based on a physical bond such as an anchor effect by using the conventional adhesive. Therefore, it is possible to obtain a bonded body 1 in a short period of time, and to prevent occurrence of peeling, bonding unevenness and the like in the bonded body 1.

Further, according to such a method, a heat treatment at a high temperature (e.g., a temperature equal to or higher than 700° C.) is unnecessary unlike the conventional solid bonding method. Therefore, the first base member 21 and the second base member 22 each formed of a material having low heat resistance can also be used for bonding them.

In addition, the first base member 21 and the second base member 22 are bonded together through the bonding film 3. Therefore, there is also an advantage that each of the constituent materials of the base members 21 and 22 is not limited to a specific kind.

For these reasons, it is possible to expand selections of the constituent materials of the first base member 21 and the second base member 22. In addition, according to the above method, the ambient atmosphere in the above bonding process is not limited to the decompressed atmosphere, and the bonding film 3 and each of the first and second base members 21 and 22 can be partially bonded together.

Further, as described below, it is possible to effectively separate the bonded body 1 into the first and second base members 21 and 22 at a desired time, e.g., when they are recycled. In this way, according to the above method, it is possible to easily manufacture a bonded body 1 without problems which would be generated in the solid bonding method.

Further, in the case where the first base member 21 and the second base member 22 have the different thermal expansion coefficients with each other, it is preferred that the first base member 21 and the second base member 22 are bonded together at as low temperature as possible. If they are bonded together at the low temperature, it is possible to further reduce thermal stress which would be generated on the bonding interfaces.

Specifically, the first base member 21 and the second base member 22 are bonded together in a state that each of the first base member 21 and the second base member 22 is heated preferably at a temperature of about 25 to 50° C., and more preferably at a temperature of about 25 to 40° C., although being different depending on the difference between the thermal expansion coefficients thereof.

In such a temperature range, even if the difference between the thermal expansion coefficients of the first base member 21 and the second base member 22 is rather large, it is possible to sufficiently reduce thermal stress which would be generated on the bonding interfaces. As a result, it is possible to reliably suppress or prevent occurrence of warp, peeling or the like in the bonded body 1.

Especially, in the case where the difference between the thermal expansion coefficients of the first base member 21 and the second base member 22 is equal to or larger than 5×10⁻⁵/K, it is particularly recommended that the first base member 21 and the second base member 22 are bonded together at a low temperature as much as possible as described above.

By appropriately setting an area and/or a shape of the bonding film 3 through which the first base member 21 and the second base member 22 are bonded together, it is possible to reduce local concentration of stress which would be generated in the bonding film 3. This makes it possible to reliably bond the first base member 21 and the second base member 22 together, even if the difference between, for example, the thermal expansion coefficients thereof is large.

Here, description will be made on a mechanism that the first base member 21 and the second base member 22 are bonded together in this process. Hereinafter, description will be representatively offered regarding a case that the hydroxyl groups are exposed in the surface 24 of the second base member 22.

In this process, in a state that the surface 34 of the bonding film 3 and the bonding surface 24 of the second base member 22 make contact with each other, the hydroxyl groups existing on the surface 34 of the bonding film 3 and the hydroxyl groups existing on the bonding surface 24 of the second base member 22 are attracted together, as a result of which hydrogen bonds are generated between the above adjacent hydroxyl groups.

It is conceived that the generation of the hydrogen bonds makes it possible to bond the surface 34 of the bonding film 3 and the bonding surface 24 of the second base member 22 together. Likewise, the surface 33 of the bonding film 3 and the bonding surface 23 of the first base member 21 are bonded together. As a result, the first base member 21 and the second base member 22 are firmly bonded together through the bonding film 3.

Depending on conditions such as a temperature and the like, the hydroxyl groups bonded together through the hydrogen bonds are dehydrated and condensed, so that the hydroxyl groups and/or water molecules are removed from the bonding interfaces between the bonding film 3 and the first and second base members 21 and 22. As a result, two atoms, to which the hydroxyl group had been bonded, are bonded together directly or via an oxygen atom.

In this way, it is conceived that the surface 34 of the bonding film 3 and the bonding surface 24 of the second base member 22 are firmly bonded together. Likewise, it is conceived that the surface 33 of the bonding film 3 and the bonding surface 23 of the first base member 21 are firmly bonded together.

In the case where the dangling bonds (the uncoupled bonds) remain on the surfaces 33 and 34 of the bonding film 3, within the bonding film 3, on the surface 23 of the first base member 21, within the first base member 21, on the surface 24 of the second base member 22 and within the second base member 22, they are also bonded together directly.

This bonding occurs in a complicated fashion so that the dangling bonds are inter-linked. As a result, network-like bonds are formed on the bonding interfaces. It is conceived that the surface 34 of the bonding film 3 and the bonding surface 24 of the second base member 22 are more firmly bonded together. Likewise, it is conceived that the surface 33 of the bonding film 3 and the bonding surface 23 of the first base member 21 are more firmly bonded together.

In this regard, an activated state that the surfaces 33 and 34 of the bonding film 3 are activated in this step [D] is reduced with time. However, in this embodiment, the energy for bonding is applied to the bonding film 3 in the state that the first base member 21 and the second base member 22 are provisionally bonded together through the bonding film 3 as described above. Therefore, a time required from the activation of the bonding film 3 to the bonding thereof to the first and second base members 21 and 22 becomes substantially zero.

This makes it possible to maximize the bonding strength between the first base member 21 and the second base member 22. In the manner described above, it is possible to obtain the bonded body 1 (the bonded body of the present invention) shown in FIG. 3C.

In the bonded body 1 obtained in this way, the bonding strength between the first base member 21 and the second base member 22 is preferably equal to or larger than 5 MPa (50 kgf/cm²), and more preferably equal to or larger than 10 MPa (100 kgf/cm²). Therefore, peeling of the bonded body 1 having such bonding strength can be sufficiently prevented.

Further, use of such a method makes it possible to efficiently manufacture the bonded body 1 in which the first base member 21 and the second base member 22 are bonded together through the bonding film 3 with the above large bonding strength.

Improvement of Bonding Strength

After the above step [D], if necessary, at least one step (step of improving the bonding strength between the first base member 21 and the second base member 22) among three steps (steps -E1-, -E2- and -E3-) described below may be applied to the bonded body 1.

This makes it possible to further improve the bonding strength between the first base member 21 and the second base member 22 (including the bonding strength between the first base member 21 and the bonding film 3 and the bonding strength between the second base member 22 and the bonding film 3) with ease.

-E1—As shown in FIG. 3D, the obtained bonded body 1 is compressed in a direction in which the first base member 21 and the second base member 22 come close to each other.

As a result, surfaces 33 and 34 of the bonding film 3 come closer to the bonding surface 23 of the first base member 21 and the bonding surface 24 of the second base member 22, respectively. It is possible to further improve the bonding strength between the first base member 21 and the second base member 22.

Further, by compressing the bonded body 1, spaces remaining in each of the boding interfaces in the bonded body 1 can be crashed to further increase bonding areas thereof. This makes it possible to further improve the bonding strength between the first base member 21 and the second base member 22.

In this regard, it is to be noted that a pressure in compressing the bonded body 1 can be appropriately adjusted, depending on the constituent materials and thicknesses of the first base member 21 and the second base member 22, conditions of a bonding apparatus, and the like.

Specifically, the pressure is preferably in the range of about 0.2 to 10 MPa, and more preferably in the range of about 1 to 5 MPa, although being slightly different depending on the constituent materials and thicknesses of the first base member 21 and the second base member 22, and the like.

By setting the pressure to the above range, it is possible to reliably improve the bonding strength between the first base member 21 and the second base member 22 in the bonded body 1. Further, although the pressure may exceed the above upper limit value, there is a fear that damages and the like occur in the first base member 21 and the second base member 22, depending on the constituent materials thereof.

A time for compressing the bonded body 1 is not particularly limited to a specific value, but is preferably in the range of about 10 seconds to 30 minutes. The compressing time can be appropriately changed, depending on the pressure in compressing the bonded body 1.

Specifically, in the case where the pressure in compressing the bonded body 1 is higher, it is possible to improve the bonding strength between the first base member 21 and the second base member 22 in the bonded body 1 even if the compressing time becomes short.

-E2—As shown in FIG. 3D, the obtained bonded body 1 is heated.

This makes it possible to further improve the bonding strength between the first base member 21 and the second base member 22 in the bonded body 1. A temperature in heating the bonded body 1 is not particularly limited to a specific value, as long as the temperature is higher than room temperature and lower than a heat resistant temperature of the bonded body 1.

Specifically, the temperature is preferably in the range of about 25 to 100° C., and more preferably in the range of about 50 to 100° C. If the bonded body 1 is heated at the temperature of the above range, it is possible to reliably improve the bonding strength between the first base member 21 and the second base member 22 in the bonded body 1 while reliably preventing them from being thermally altered and deteriorated.

Further, a heating time is not particularly limited to a specific value, but is preferably in the range of about 1 to 30 minutes.

In the case where both steps -E1— and -E2— are performed, the steps are preferably performed simultaneously. In other words, as shown in FIG. 3D, the bonded body 1 is preferably heated while being compressed. By doing so, an effect by compressing and an effect by heating are exhibited synergistically. It is possible to particularly improve the bonding strength between the first base member 21 and the second base member 22 in the bonded body 1.

-E3—An ultraviolet ray is irradiated on the obtained bonded body 1.

This makes it possible to increase the number of chemical bonds formed between the first and second base members 21 and 22 and the bonding film 3 in the bonded body 1. As a result, it is possible to particularly improve the bonding strength between the first base member 21 and the second base member 22. Conditions of the ultraviolet ray irradiated at this time can be the same as those of the ultraviolet ray irradiated in the step [D] described above.

Further, in the case where this step -E3— is performed, at least one of the first base member 21 and the second base member 22 need to have translucency (permeability for the ultraviolet ray). It is possible to reliably irradiate the ultraviolet ray on the bonding film 3 by irradiating it from a side of the base member having the translucency (one side of the bonding film 3 or both sides of the bonding film 3).

Through the steps described above, it is possible to easily improve the bonding strength between the first member 21 and the second base member 22 in the bonded body 1.

Although in the above embodiment, the liquid coating 3A is formed on the bonding surface 23 of the first base member 21, the liquid coating 3A may be formed on the bonding surface 24 of the second base member 22 or the liquid coatings 3A may be formed on both the bonding surface 23 and the bonding surface 24.

Further, in the case where the liquid coating 3A is formed on at least one of the bonding surface 23 and the bonding surface 24, a solution or dispersion liquid of the silicone material may be supplied on the other bonding surface or the gap members 32 may be provided on the other bonding surface before the step [B] is performed.

Separating Method of Bonded Body

Next, description will be made on a separating method of the bonded body according to the present invention.

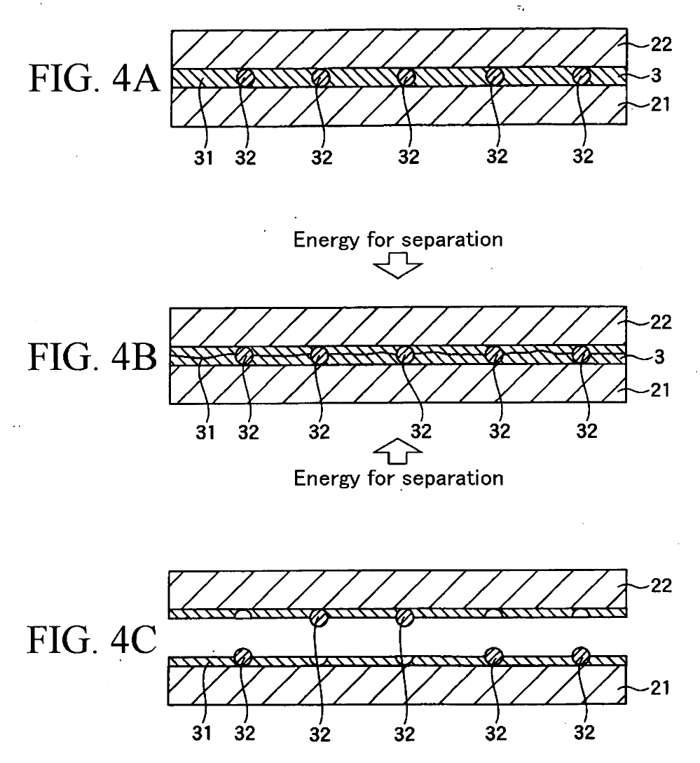

FIGS. 4A to 4C are sectional views for explaining steps of separating the bonded body shown in FIG. 1. In this regard, it is to be noted that in the following description, an upper side in each of FIGS. 4A to 4C will be referred to as “upper” and a lower side thereof will be referred to as “lower”.

[1] First, the bonded body 1 described above is prepared as a bonded body to which the separating method of the bonded body according to the present invention is applied. In the bonded body 1, the first base member 21 and the second base member 22 are boded together through the bonding film 3 containing the silicone material (see FIG. 4A).

In the case where in the following step [2], a method of irradiating an energy beam (e.g., an ultraviolet ray) on the bonding film 3 is used as a method of applying energy for separation to the bonding film 3, a base member having translucency of the energy beam (e.g., the ultraviolet ray) is used as at least one of the first base member 21 and the second base member 22, that is, at least a base member which is provided on the irradiation side of the energy beam.

Examples of a constituent material of the base member having translucency of the energy beam include: a resin material such as polyolefin (e.g., polyethylene, polypropylene, ethylene-propylene copolymer, ethylene-acrylate copolymer, ethylene-acrylic acid copolymer, ionomer, polybutene-1, ethylene-vinyl acetate-based copolymer (EVA)), polyester, polycarbonate or PMMA; a ceramics-based material having translucency of the ultraviolet ray such as MgAl₂O₄.

[2] Next, the energy for separation is applied to the bonding film 3 of the bonded body 1 (see FIG. 4B). This makes it possible to break a part of molecular bonds of the silicone compounds constituting the silicone material. As a result, cleavage is generated within the bonding film 3, whereby the second base member 22 can be peeled off (removed) from the first base member 21 as shown in FIG. 4C.

Here, it is conceived that the generation of the cleavage within the bonding film 3 due to the application of the energy for separation results from the following mechanism. In the case where the silicone material contained in the bonding film 3 is constituted of the silicone compounds each having the polydimethylsiloxane chemical structure as the main chemical structure thereof, when the energy for separation is applied to the bonding film 3, Si—CH₃ bonds of the polydimethylsiloxane chemical structures are broken and reacted with water molecules or the like contained in an ambient atmosphere, to thereby generate, for example, methane.

This methane exists in the form of gas (as a methane gas) within the bonding film 3 of the bonded body 1. The gas occupies large volume within the bonding film 3. In portions where the gas is generated, the bonding film 3 is expanded. As a result, Si—O bonds of the polydimethylsiloxane chemical structures are also broken in these portions, and therefore the cleavage is generated within the bonding film 3.

The application of the energy for separation to the bonding film 3 may be performed in any ambient atmosphere, as long as the atmosphere contains the water molecules, but it is preferably performed in an air atmosphere. In this case, since the air atmosphere contains a sufficient amount of the water molecules, it is possible to reliably generate the cleavage within the bonding film 3 without using a special apparatus.

In this way, in order to generate the cleavage within the bonding film 3, it is needed that the bonding film 3 is not formed of SiOₓ which is an inorganic matter, but formed of a material composed of compounds in which the inorganic matter and an organic matter are chemically bonded together, that is, the silicone material. Therefore, in the bonding film 3, an abundance ratio of the silicon atoms to the carbon atoms is preferably in the range of about 2:8 to 8:2, and more preferably in the range of about 3:7 to 7:3.

By setting the abundance ratio of the silicon atoms to the carbon atoms to the above range, the bonding film 3 can exhibit the excellent function thereof, and become a film capable of generating the cleavage therewithin due to the application of the energy for separation.

Further, it is preferred that magnitude of the energy for separation is larger than that of the energy for bonding. This makes it possible to selectively break the Si—CH₃ bonds present in the vicinity of each of the surfaces 33 and 34 of the bonding film 3 when applying the energy for bonding thereto, and to selectively break the Si—CH₃ bonds present within the bonding film 3 when applying the energy for separation thereto.

As a result, the bonding property is developed in the vicinity of each of the surfaces 33 and 34 of the bonding film 3 when applying the energy for bonding thereto, whereas the cleavage is generated within the bonding film 3 when applying the energy for separation thereto.

Like the energy for bonding described above, the energy for separation may be applied to the bonding film 3 by any method. Examples of the method include: a method in which an energy beam is irradiated on the bonding film 3; a method in which the bonding film 3 is heated; a method in which a compressive force (physical energy) is applied to the bonding film 3; a method in which the bonding film 3 is exposed to plasma (that is, plasma energy is applied to the bonding film 3); a method in which the bonding film 3 is exposed to an ozone gas (that is, chemical energy is applied to the bonding film 3); and the like.

Among these methods, in this embodiment, it is particularly preferred that at least one of the method in which the energy beam is irradiated on the bonding film 3 and the method in which the bonding film 3 is heated is used as the method for applying the energy for separation to the bonding film 3. Such a method can selectively apply the energy for separation to the bonding film 3 relatively easily. This makes it possible to more reliably generate the cleavage within the bonding film 3.

Especially, in this embodiment, the bonded body 1 includes the bonding film 3 containing the above mentioned gap members 32. Therefore, in the case where the thermal expansion coefficient of the silicone portion 31 and the thermal expansion coefficient of each of the gap members 32 are different from each other, when the energy for separation is applied to the bonding film 3, the cleavage can be positively generated on boundary surfaces between the silicone portion 31 and the gap members 32 according to temperature rise of the bonding film 3.

This makes it possible to more smoothly separate the bonded body 1 into the first base member 21 and the second base member 22.

Examples of the energy beam include the same energy beam as described in the energy for bonding. Among these energy beams, it is particularly preferred to use the ray such as the ultraviolet ray or the laser beam. Use of the ray makes it possible to reliably generate the cleavage within the bonding film 3 while preventing alteration and deterioration of the first base member 21 and the second base member 22.

In this regard, a wavelength of the ultraviolet ray is preferably in the range of about 126 to 300 nm, and more preferably in the range of about 126 to 200 nm.

Further, in the case where an UV lamp is used, power of the UV lamp is preferably in the range about of 1 mW/cm² to 1 W/cm², and more preferably in the range of about 5 to 50 mW/cm², although being different depending on an area of each of the surfaces 33 and 34 of the bonding film 3. In this case, a distance between the UV lamp and the bonding film 3 is preferably in the range of about 3 to 3,000 mm, and more preferably in the range of about 10 to 1,000 mm.

Further, a time for irradiating the ultraviolet ray is set to a time required for generation of the cleavage within the bonding film 3. Specifically, the time is preferably in the range of about 10 to 180 minutes, and more preferably in the range of about 30 to 60 minutes, although being slightly different depending on an amount of the ultraviolet ray, the constituent material of the bonding film 3, and the like. The ultraviolet ray may be irradiated temporally, continuously or intermittently (in a pulse-like manner).

On the other hand, examples of the laser beam include: a pulse oscillation laser (a pulse laser) such as an excimer laser; a continuous oscillation laser such as a carbon dioxide laser or a semiconductor laser; and the like. Among these lasers, it is preferred that the pulse laser is used.

Use of the pulse laser makes it difficult to accumulate of heat in a portion of the bonding film 3 where the laser beam is irradiated with time. Therefore, it is possible to reliably prevent alteration and deterioration of the first base member 21 and the second base member 22 due to the heat accumulated.

In other words, by using the pulse laser, a laser beam having higher energy density can be irradiated on the bonding film 3 while preventing the alteration and deterioration of the first base member 21 and the second base member 22. This makes it possible to effectively generate the cleavage within the bonding film 3.

In the case where influence of the heat is taken into account, it is preferred that a pulse width of the pulse laser is as small as possible. Specifically, the pulse width is preferably equal to or smaller than 1 ps (picosecond), and more preferably equal to or smaller than 500 fs (femtoseconds). By setting the pulse width to the above range, it is possible to reliably suppress the influence of the heat generated in the bonding film 3 due to the irradiation with the laser beam.

Further, by setting the pulse width to the above range, it is possible to prevent accumulate of the heat in the portion of the bonding film 3 where the laser beam is irradiated, and expanse of the portion having a high temperature in a thickness direction of the bonding film 3 (that is, the irradiating direction of the laser beam).

For these reasons, it is possible to adjust a position (a cleavage position) which the cleavage would be generated within the bonding film 3 with high accuracy. In this regard, it is to be noted that the pulse laser having the small pulse width of the above range is called “femtosecond laser”.

A wavelength of the laser beam is not particularly limited to a specific value, but is preferably in the range of about 200 to 1200 nm, and more preferably in the range of about 400 to 1,000 nm. Further, in the case of the pulse laser, peak power of the laser beam is preferably in the range of about 0.1 to 10 W, and more preferably in the range of about 1 to 5 W, although being different depending on the pulse width thereof.

Moreover, a repetitive frequency of the pulse laser is preferably in the range of about 0.1 to 100 kHz, and more preferably in the range of about 1 to 10 kHz. By setting the frequency of the pulse laser to the above range, the Si—CH₃ bonds can be selectively broken.

Further, the irradiation of the energy beam, which is used for generating the cleavage within the bonding film 3, to the bonding film 3 may be performed in any ambient atmosphere. Specifically, examples of the ambient atmosphere include: an oxidizing gas atmosphere such as air or an oxygen gas; a reducing gas atmosphere such as a hydrogen gas; an inert gas atmosphere such as a nitrogen gas or an argon gas; a decompressed (vacuum) atmosphere obtained by decompressing any one of these ambient atmospheres; and the like.

Among these ambient atmospheres, it is particularly preferred that the irradiation is performed in the inert gas atmosphere (particularly, the nitrogen gas atmosphere). This makes it possible to effectively apply the energy for separation within the bonding film 3 while preventing alteration and deterioration of the first base member 21 and the second base member 22, to thereby generate the cleavage within the bonding film 3 more reliably.

In the case where the bonding film 3 is heated, a heating temperature of the bonded body 1 is preferably in the range of about 100 to 400° C., and more preferably in the range of about 150 to 300° C. By heating the bonded body 1 in such a heating temperature range, it is possible to reliably generate the cleavage within the bonding film 3 while preventing alteration and deterioration of the first base member 21 and the second base member 22 reliably.

Further, a heating time is set to a time for generating the cleavage within the bonding film 3. Specifically, the time is preferably in the range of about 10 to 180 minutes, and more preferably in the range of about 30 to 60 minutes, although being slightly different depending on the heating temperature, the constituent material of the bonding film 3, and the like.

In this regard, the method of applying the energy for bonding to the bonding film 3 and the method of applying the energy for separation thereto may be the same or different from each other, but it is preferred that they are the same. Since the magnitude of the energy for bonding and the magnitude of the energy for separation are controlled relatively easily, in the case where the same method is used, the magnitude of the energy for separation can be easily adjusted so as to become larger than that of the energy for bonding.

Further, these energies can be applied to the bonding film 3 using a single apparatus, namely the manufacture and separation of the bonded body 1 can be carried out using the single apparatus. This makes it possible to reduce a cost for manufacturing and separating the bonded body 1.

In this way, by using an easy method, that is, the above method of applying the energy for separation to the bonding film 3, the second base member 22 can be peeled off from the first base member 21 effectively at a desired time, e.g., when the base members are recycled. Therefore, even if the constituent materials of the base members 21 and 22 are different from each other, they can be reused independently after fractionation thereof. This makes it possible to improve a recycle rate of the bonded body 1.

Liquid Droplet Ejection Head

Now, description will be made on an embodiment of a liquid droplet ejection head in which the bonded body according to the present invention is used.

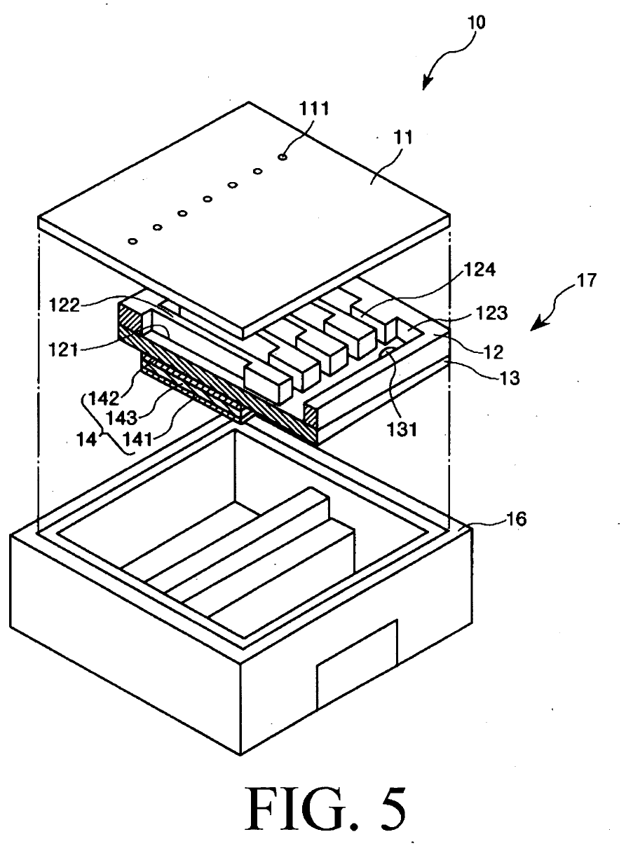

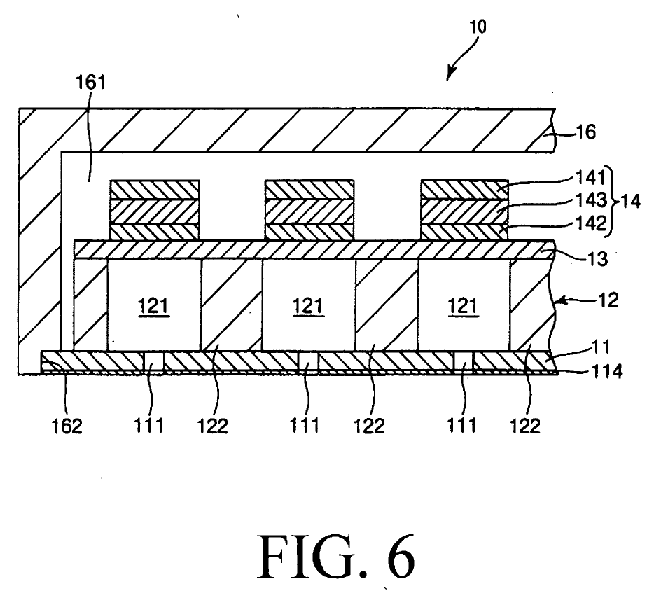

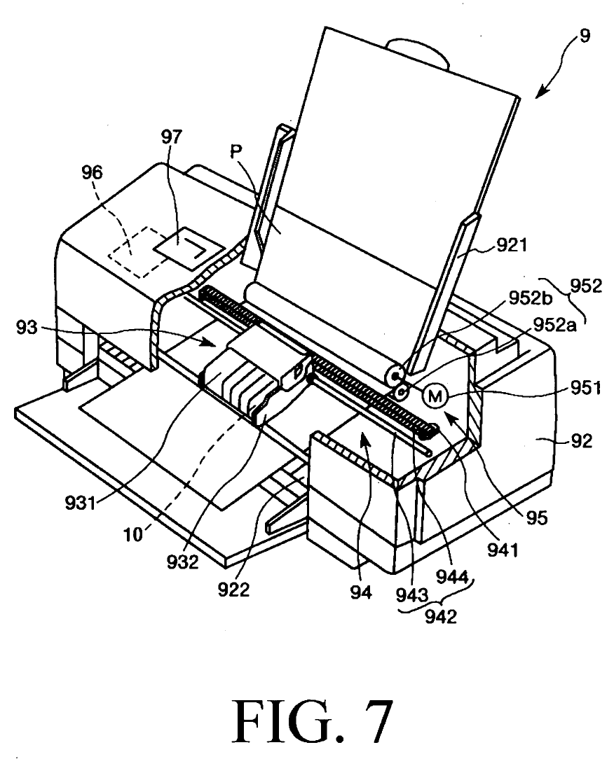

FIG. 5 is an exploded perspective view showing an ink jet type recording head (a liquid droplet ejection head) in which the bonded body according to the present invention is used. FIG. 6 is a section view illustrating a main portion of the ink jet type recording head shown in FIG. 5. FIG. 7 is a schematic view showing an embodiment of an ink jet printer equipped with the ink jet type recording head shown in FIG. 5. In FIG. 5, the ink jet type recording head is shown in an inverted state as distinguished from a typical use state.

The ink jet type recording head 10 shown in FIG. 5 is mounted to the ink jet printer 9 shown in FIG. 7.

The ink jet printer 9 shown in FIG. 7 includes a printer body 92, a tray 921 provided in an upper rear portion of the printer body 92 for holding recording paper sheets P, a paper discharging port 922 provided in a lower front portion of the printer body 92 for discharging the recording paper sheets P therethrough, and an operation panel 97 provided on an upper surface of the printer body 92.

The operation panel 97 is formed from, e.g., a liquid crystal display, an organic EL display, an LED lamp or the like. The operation panel 97 includes a display portion (not shown) for displaying an error message and the like and an operation portion (not shown) formed from various kinds of switches.

Within the printer body 92, there are provided a printing device (a printing means) 94 having a reciprocating head unit 93, a paper sheet feeding device (a paper sheet feeding means) 95 for feeding the recording paper sheets P into the printing device 94 one by one and a control unit (a control means) 96 for controlling the printing device 94 and the paper sheet feeding device 95.

Under control of the control unit 96, the paper sheet feeding device 95 feeds the recording paper sheets P one by one in an intermittent manner. The recording paper sheet P passes near a lower portion of the head unit 93. At this time, the head unit 93 makes reciprocating movement in a direction generally perpendicular to a feeding direction of the recording paper sheet P, thereby printing the recording paper sheet P.

In other words, an ink jet type printing operation is performed, during which time the reciprocating movement of the head unit 93 and the intermittent feeding of the recording paper sheets P act as primary scanning and secondary scanning, respectively.

The printing device 94 includes a head unit 93, a carriage motor 941 serving as a driving power source of the head unit 93 and a reciprocating mechanism 942 rotated by the carriage motor 941 for reciprocating the head unit 93.

The head unit 93 includes an ink jet type recording head 10 (hereinafter, simply referred to as “head 10”) having a plurality of nozzle holes 111 formed in a lower portion thereof, an ink cartridge 931 for supplying an ink to the head 10 and a carriage 932 carrying the head 10 and the ink cartridge 931.

Full color printing becomes available by using, as the ink cartridge 931, a cartridge of the type filled with ink of four colors, i.e., yellow, cyan, magenta and black.

The reciprocating mechanism 942 includes a carriage guide shaft 943 whose opposite ends are supported on a frame (not shown) and a timing belt 944 extending parallel to the carriage guide shaft 943.

The carriage 932 is reciprocatingly supported by the carriage guide shaft 943 and fixedly secured to a portion of the timing belt 944.

If the timing belt 944 wound around a pulley is caused to run in forward and reverse directions by operating the carriage motor 941, the head unit 93 makes reciprocating movement along the carriage guide shaft 943. During this reciprocating movement, an appropriate amount of the ink is ejected from the head 10 to print the recording paper sheets P.

The paper sheet feeding device 95 includes a paper sheet feeding motor 951 serving as a driving power source thereof and a pair of paper sheet feeding rollers 952 rotated by means of the paper sheet feeding motor 951.

The paper sheet feeding rollers 952 include a driven roller 952a and a driving roller 952b, both of which face toward each other in a vertical direction, with a paper sheet feeding path (the recording paper sheet P) remained therebetween. The driving roller 952b is connected to the paper sheet feeding motor 951.

Thus, the paper sheet feeding rollers 952 are able to feed the plurality of the recording paper sheets P, which are held in the tray 921, toward the printing device 94 one by one. In place of the tray 921, it may be possible to employ a construction that can removably hold a paper sheet feeding cassette containing the recording paper sheets P.

The control unit 96 is designed to perform printing by controlling the printing device 94 and the paper sheet feeding device 95 based on printing data inputted from a host computer, e.g., a personal computer or a digital camera.

Although not shown in the drawings, the control unit 96 is mainly comprised of a memory that stores a control program for controlling the respective parts an d the like, a piezoelectric element driving circuit for driving piezoelectric elements (vibration sources) 14 to control an ink ejection timing, a driving circuit for driving the printing device 94 (the carriage motor 941), a driving circuit for driving the paper sheet feeding device 95 (the paper sheet feeding motor 951), a communication circuit for receiving the printing data from the host computer, and a CPU electrically connected to the memory and the circuits for performing various kinds of control with respect to the respective parts.

Electrically connected to the CPU are a variety of sensors capable of detecting, e.g., a remaining amount of the ink in the ink cartridge 931 and a position of the head unit 93.

The control unit 96 receives the printing data through the communication circuit and then stores them in the memory. The CPU processes these printing data and outputs driving signals to the respective driving circuits, based on the data thus processed and data inputted from the variety of sensors. Responsive to these signals, the piezoelectric elements 14, the printing device 94 and the paper sheet feeding device 95 come into operation, thereby printing the recording paper sheets P.

Hereinafter, the head 10 will be described in detail with reference to FIGS. 5 and 6.

The head 10 includes a head main body 17 and a base body 16 for receiving the head main body 17. The head main body 17 includes a nozzle plate 11, an ink chamber base plate 12, a vibration plate 13 and a plurality of piezoelectric elements (vibration sources) 14 bonded to the vibration plate 13. The head 10 constitutes a piezo jet type head of on-demand style.

The nozzle plate 11 is made of, e.g., a silicon-based material such as SiO₂, SiN or quartz glass, a metal-based material such as Al, Fe, Ni, Cu or alloy containing these metals, an oxide-based material such as alumina or ferric oxide, a carbon-based material such as carbon black or graphite, and the like.

The plurality of the nozzle holes 111 for ejecting ink droplets therethrough are formed in the nozzle plate 11. A pitch of the nozzle holes 111 is suitably set according to a degree of printing accuracy.

The ink chamber base plate 12 is fixed or secured to the nozzle plate 11. In the ink chamber base plate 12, there are formed a plurality of ink chambers (cavities or pressure chambers) 121, a reservoir chamber 123 for reserving the ink supplied from the ink cartridge 931 and a plurality of supply ports 124 through which the ink is supplied from the reservoir chamber 123 to the respective ink chambers 121. These chambers 121, 123 and 124 are defined by the nozzle plate 11, side walls (barrier walls) 122 and the below mentioned vibration plate 13.

The respective ink chambers 121 are formed into a reed shape (a rectangular shape) and are arranged in a corresponding relationship with the respective nozzle holes 111. Volume of each of the ink chambers 121 can be changed in response to vibration of the vibration plate 13 as described below. The ink is ejected from the ink chambers 121 by virtue of this volume change.

As a base material of which the ink chamber base plate 12 is made, it is possible to use, e.g., a monocrystalline silicon substrate, various kinds of glass substrates or various kinds of resin substrates. Since these substrates are all generally used in the art, use of these substrates makes it possible to reduce a manufacturing cost of the head 10.

The vibration plate 13 is bonded to an opposite side of the ink chamber base plate 12 from the nozzle plate 11. The plurality of the piezoelectric elements 14 are provided on an opposite side of the vibration plate 13 from the ink chamber base plate 12.

In a predetermined position of the vibration plate 13, a communication hole 131 is formed through a thickness of the vibration plate 13. The ink can be supplied from the ink cartridge 931 to the reservoir chamber 123 through the communication hole 131.

Each of the piezoelectric elements 14 includes an upper electrode 141, a lower electrode 142 and a piezoelectric body layer 143 interposed between the upper electrode 141 and the lower electrode 142. The piezoelectric elements 14 are arranged in alignment with generally central portions of the respective ink chambers 121.

The piezoelectric elements 14 are electrically connected to the piezoelectric element driving circuit and are designed to be operated (vibrated or deformed) in response to the signals supplied from the piezoelectric element driving circuit.

The piezoelectric elements 14 act as vibration sources. The vibration plate 13 is vibrated by operation of the piezoelectric elements 14 and has a function of instantaneously increasing internal pressures of the ink chambers 121.

The base body 16 is made of, e.g., various kinds of resin materials or various kinds of metallic materials. The nozzle plate 11 is fixed to and supported by the base body 16. Specifically, in a state that the head main body 17 is received in a recess portion 161 of the base body 16, an edge of the nozzle plate 11 is supported on a shoulder 162 of the base body 16 extending along an outer circumference of the recess portion 161.

When bonding the nozzle plate 11 and the ink chamber base plate 12, the ink chamber base plate 12 and the vibration plate 13, and the nozzle plate 11 and the base body 16 as mentioned above, the method of the present invention is used in at least one bonded portion thereof.

In other words, the bonded body of the present invention is used in at least one of a bonded body in which the nozzle plate 11 and the ink chamber base plate 12 are bonded together, a bonded body in which the ink chamber base plate 12 and the vibration plate 13 are bonded together, and a bonded body in which the nozzle plate 11 and the base body 16 are bonded together.

Here, in the case where the bonded body in which the nozzle plate 11 and the ink chamber base plate 12 are bonded together is the bonded body of the present invention, one member (component) of the nozzle plate 11 and the ink chamber base plate 12 is the first base member and the other member (component) is the second base member.

Further, in the case where the bonded body in which the ink chamber base plate 12 and the vibration plate 13 are bonded together is the bonded body of the present invention, one member of the ink chamber base plate 12 and the vibration plate 13 is the first base member and the other member is the second base member.

Furthermore, in the case where the bonded body in which the nozzle plate 11 and the base body 16 are bonded together is the bonded body of the present invention, one member of the nozzle plate 11 and the base body 16 is the first base member and the other member is the second base member.

In such a head 10, two members constituting each of them are bonded together through the bonding film 3 in the bonded portion. Therefore, the head 10 exhibits increased bonding strength and chemical resistance in bonding interfaces (the bonded portion), which in turn leads to increased durability and liquid tightness against the ink reserved in the respective ink chambers 121. As a result, the head 10 is rendered highly reliable.

Furthermore, highly reliable bonding is available even at an extremely low temperature. There is an advantage that a head with an increased area can be fabricated from members made of materials having different linear expansion coefficients.

Moreover, in the case where the bonded body of the present invention is used in a part of the head 10, it is possible to manufacture a head 10 having high dimensional accuracy. Therefore, it is possible to control an ejecting direction of ink droplets ejected from the head 10, and a distance between the head 10 and each of the recording paper sheets P with high accuracy. This makes it possible to improve a quality of a printing recorded using the ink jet printer 9 provided with such a head 10.

When such a head 10 is recycled (deconstructed), by using the separating method of the present invention, it is possible to reliably separate at least one of the above bonded bodies such as the bonded body in which the nozzle plate 11 and the ink chamber base plate 12 are bonded together, the bonded body in which the ink chamber base plate 12 and the vibration plate 13 are bonded together, and the bonded body in which the nozzle plate 11 and the base body 16 are bonded together.

As a result, each of the bonded bodies is separated into the nozzle plate 11 and the ink chamber base plate 12, the ink chamber base plate 12 and the vibration plate 13, or the nozzle plate 11 and the base body 16. Since these members (these base members) can be recycled independently, it is possible to improve a recycle rate of the head 10.

With the head 10 set forth above, no deformation occurs in the piezoelectric body layer 143, in the case where a predetermined ejection signal has not been inputted from the piezoelectric element driving circuit, that is, a voltage has not been applied between the upper electrode 141 and the lower electrode 142 of each of the piezoelectric elements 14.

For this reason, no deformation occurs in the vibration plate 13 and no change occurs in the volumes of the ink chambers 121. Therefore, the ink droplets have not been ejected from the nozzle holes 111.

On the other hand, the piezoelectric body layer 143 is deformed, in the case where the predetermined ejection signal is inputted from the piezoelectric element driving circuit, that is, the voltage is applied between the upper electrode 141 and the lower electrode 142 of each of the piezoelectric elements 14.

Thus, the vibration plate 13 is heavily deflected to change the volumes of the ink chambers 121. At this moment, pressures within the ink chambers 121 are instantaneously increased and the ink droplets are ejected from the nozzle holes 111.

when one ink ejection operation has ended, the piezoelectric element driving circuit ceases to apply the voltage between the upper electrode 141 and the lower electrode 142. Thus, the piezoelectric elements 14 are returned substantially to their original shapes, thereby increasing the volumes of the ink chambers 121.

At this time, a pressure acting from the ink cartridge 931 toward the nozzle holes 111 (a positive pressure) is imparted to the ink. This prevents an air from entering the ink chambers 121 through the nozzle holes 111, which ensures that the ink is supplied from the ink cartridge 931 (the reservoir chamber 123) to the ink chambers 121 in a quantity corresponding to the quantity of the ink ejected.

By sequentially inputting ejection signals from the piezoelectric element driving circuit to the piezoelectric elements 14 lying in target printing positions, it is possible to print an arbitrary (desired) letter, figure or the like.

The head 10 may be provided with thermoelectric conversion elements in place of the piezoelectric elements 14. In other words, the head 10 may have a configuration in which the ink is ejected using a thermal expansion of a material caused by the thermoelectric conversion elements (which is sometimes called a bubble jet method wherein the term “bubble jet” is a registered trademark).

In the head 10 configured as above, a film 114 is formed on the nozzle plate 11 in an effort to impart liquid repellency thereto. By doing so, it is possible to reliably prevent the ink droplets from adhering to peripheries of the nozzle holes 111, which would otherwise occur when the ink droplets are ejected from the nozzle holes 111.

As a result, it becomes possible to make sure that the ink droplets ejected from the nozzle holes 111 are reliably landed (hit) on target regions.

Transmission Screen

Next, description will be made on an embodiment of a transmission screen in which the bonded body according to the present invention is used.

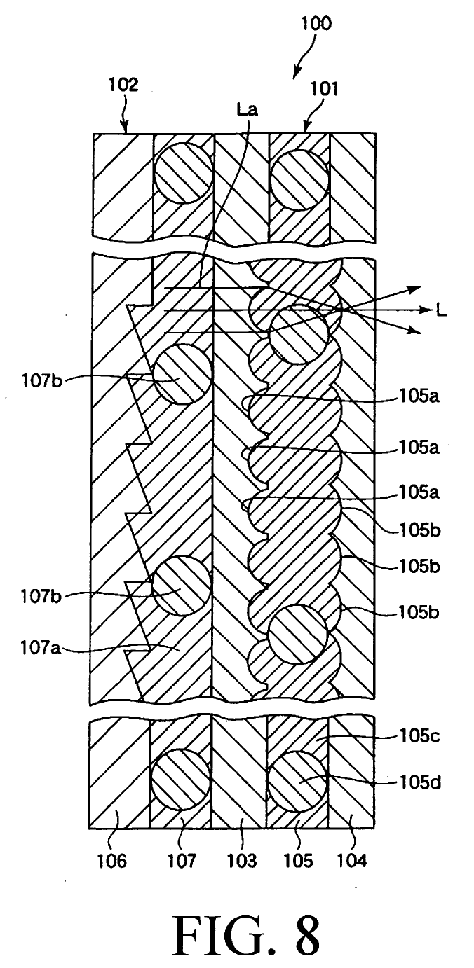

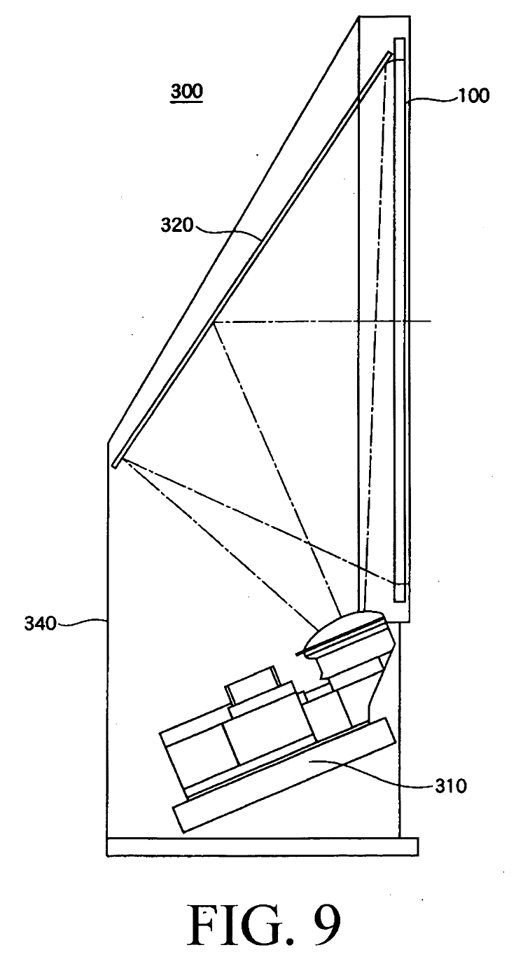

FIG. 8 is a longitudinal sectional view schematically showing a preferred embodiment of a transmission screen in which the bonded body according to the present invention is used. FIG. 9 is a view schematically showing a rear-type projector provided with the transmission screen shown in FIG. 8.

In the following description, a left side and a right side in FIG. 8 are referred to as “light incident side (or light incident surface)” and “light emission side (or light emission surface)”, respectively.

In this regard, in the following description, the light incident side and the light emission side respectively indicate “light incident side of light for obtaining an image light” and “light emission side thereof”, and they do not respectively indicate “light incident side of outside light or the like” and “light emission side thereof”, if not otherwise specified.

As shown in FIG. 8, a transmission screen 100 includes a microlens portion 101 and a Fresnel lens portion 102. In such a transmission screen 100, the image light emitted from a projection lens is refracted by the Fresnel lens portion 102 to form parallel light La, and then the parallel light La is diffused by the microlens portion 101.

Hereinafter, the respective components constituting the transmission screen 100 will be described in detail.

The microlens portion 101 includes a pair of a substrate with concave portions 103 and a substrate with concave portions 104, and a microlens substrate 105 provided between the pair of the substrate with concave portions 103 and the substrate with concave portions 104.

A plurality of concave portions corresponding to a plurality of microlenses (convex lenses) 105a of the microlens substrate 105 are formed on the substrate with concave portions 103. On the other hand, a plurality of concave portions corresponding to a plurality of convex curved surfaces 105b of the microlens substrate 105 are formed on the substrate with concave portions 104.

Further, each of the substrate with concave portions 103 and the substrate with concave portions 104 is formed of a material having a refractive index different from that of the microlens substrate 105. In the microlens substrate 105, the microlenses 105a and the convex curved surfaces 105b can independently exhibit their optical properties.

The microlens substrate 105 is formed of the same material as the above bonding film 3. In other words, the microlens substrate 105 has a function as a bonding film through which the above substrate with concave portions 103 and substrate with concave portions 104 are bonded together, in addition to an optical function which will be described below. Such a microlens substrate 105 can be formed in the same manner as described in the bonding film 3.

Such a microlens substrate 105 includes a silicone portion 105c formed of a silicone material composed of silicone compounds as a major component thereof and gap members (spacers) 105d.

The gap members 105d are formed of a material having a refractive index nearly equal to that of the silicone portion 105c. Even in the case where the gap members 105d are located in regions corresponding to the concave portions formed in the substrate with concave portions 103 and the substrate with concave portions 104, use of the gap members 105d each formed of such a material makes it possible to effectively prevent an optical property of the obtained microlens substrate 105 from being adversely affected.

Therefore, it is possible to place a relatively large number of the gap members 105d in wide regions of major surfaces (on the sides of the surfaces on which the concave portions are formed) of the substrate with concave portions 103 and the substrate with concave portions 104.

This makes it possible to eliminate an adverse affect with respect to the microlens substrate 105, which would occur due to deflection and the like of the substrate with concave portions 103 and the substrate with concave portions 104. As a result, a thickness of the microlens substrate 105 can be controlled more reliably.

Although the gap members 105d are formed of the material having the refractive index nearly equal to that of the silicone portion 105c, more specifically, an absolute value of a difference between an absolute refractive index of the constituent material of each of the gap members 105d and an absolute refractive index of the constituent material of the silicone portion 105c is preferably 0.20 or less, more preferably 0.10 or less, and even more preferably 0.02 or less. Especially, it is preferred that the silicone portion 105c and the gap members 105d are formed of the same material with each other.

A shape of each of the gap members 105d is not particularly limited to a specific type. It is preferred that the shape of each of the gap members 105d is a substantially spherical shape or a substantially cylindrical shape. In the case where each of the gap members 105d has such a shape, a diameter of each of the gap members 105d is preferably in the range of 10 to 300 μm, more preferably in the range of 30 to 200 μm, and even more preferably in the range of 30 to 170 μm.

The microlenses substrate (a lens substrate) 105 is a component constituting the transmission screen 100. As shown in FIG. 8, the microlenses substrate 105 has the plurality of the microlens (convex lenses) 105a on the light incident side thereof and the plurality of the fine convex curved surfaces 105b on the light emission side thereof.

A shape of each of the microlenses 105a in a planer view thereof (hereinafter, simply referred to as “shape of each of microlenses 105a ” on occasion) is not particularly limited to a specific type, but it is preferred that the shape of each of the microlenses 105a is a substantially circular shape or a substantially elliptic shape (in this case, such a shape includes a substantial bale shape or a shape in which top and bottom portions of a substantially circular shape are cut).

In the case where each of the microlenses 105a has the substantially circular shape or the substantially elliptic shape, it is possible to particularly improve an angle of view characteristics of the transmission screen 100 provided with the microlens substrate 105. In particular, in this case, it is possible to improve the angle of view characteristics in both horizontal and vertical directions of the transmission screen 100 provided with the microlens substrate 105.

A diameter of each of the microlenses 105a (in the case where each of the microlenses 105a has the elliptic shape, a length in a minor axis direction thereof) is preferably in the range of 10 to 500 μm, more preferably in the range of 30 to 300 μm, and even more preferably in the range of 50 to 100 μm.

By setting the diameter of each of the microlenses 105a to the above range, it is possible to obtain sufficient resolution in an image projected on a screen and further enhance productivity of the microlens substrate 105 (the transmission screen 100).

In this regard, in the microlens substrate 105, a pitch between the microlenses 105a which are adjacent together is preferably in the range of 10 to 500 μm, more preferably in the range of 30 to 300 μm, and even more preferably in the range of 50 to 100 μm.

Further, a curvature radius o f each of the microlenses 105a (in the case where each of the microlenses 105a has the elliptic shape, a curvature radius in a minor axis direction thereof) is preferably in the range of 5 to 250 μm, more preferably in the range of 15 to 150 μm, and even more preferably in the range of 25 to 50 μm.

By setting the curvature radius of each of the microlenses 105a to the above range, an angle of view characteristics of the transmission screen 100 provided with the microlens substrate 105. In particular, in this case, it is possible to improve the angle of view characteristics in both horizontal and vertical directions of the transmission screen 100 provided with the microlens substrate 105.

Furthermore, an arrangement pattern of the microlenses 105a is not particularly limited to a specific type. The arrangement pattern may be either an arrangement pattern in which the microlenses 105a are arranged in a regular manner (for example, a lattice-shaped manner, a honeycomb-shaped manner, a houndstooth check manner) or an arrangement pattern in which the microlenses 105a are arranged in an optically random manner (the microlenses 105a are randomly arranged with each other in the planer view from the major surface of the microlens substrate 105).

However, it is preferred that the microlenses 105a are arranged in the regular manner, that is, the houndstooth check manner. In the case where the microlenses 105a are arranged in such a regular manner, it is possible to prevent interference of the light to a liquid crystal light valve or a Fresnel lens from occurring more efficiently. Therefore, it is possible to more effectively prevent moire from occurring and to maximize a lens effect.

On the other hand, in the case where the microlenses 105a are arranged in such a random manner, it is possible to prevent interference of the light to the liquid crystal light valve or the Fresnel lens from occurring more efficiently, and therefore it is possible to prevent moire from occurring almost completely. This makes it possible to obtain an excellent transmission screen 100 having a high display quality.

Further, a ratio of an area (a projected area) occupied by all the microlenses (a lens portion) 105a in a usable area where the microlenses 105a are formed with respect to the entire usable area is preferably 90% or more, and more preferably 96% or more when the microlens substrate 105 is viewed from the light incident side thereof.

In the case where the ratio of the area occupied by all the microlenses 105a in the usable area with respect to the entire usable area is 90% or more, it is possible to reduce straight light passing through an area other than the area where the microlenses 105a reside. This makes it possible to further enhance light use efficiency of the transmission screen 100 provided with the microlens substrate 105.

On the other hand, each of the plurality of the fine convex curved surfaces (portions that prevent total reflection of light) 105b provided on the light emission side of the microlens substrate 105 has a curvature radius larger than that of each of the microlenses 105a described above.

In the case where such convex curved surfaces 105b are provided in the microlens substrate 105, it is possible to effectively prevent light entered from the light incident side surface (a first surface) of the microlens substrate 105 form being totally reflected.

This makes it possible to efficiently pass the light through the microlens substrate 105 and to efficiently reflect diffusely light entered from the light emission side surface (a second surface) of the microlens substrate 105. As a result, it is possible to obtain an image having especially excellent contrast.

A shape of each of the convex curved surfaces 105b in a planer view thereof (hereinafter, simply referred to as “shape of each of convex curved surfaces 105b ” on occasion) is not particularly limited to a specific type. However, it is preferred that each of the convex curved surfaces 105b has a shape corresponding to that of each of the microlenses 105a, that is, the shape of each of the convex curved surfaces 105b and the shape of each of the microlenses 105a are homothetic.

Specifically, if each of the microlenses 105a has the substantially circular shape, it is preferred that each of the convex curved surfaces 105b also has a substantially circular shape, and if each of the microlenses 105a has the substantially elliptic shape, it is preferred that each of the convex curved surfaces 105b also has a substantially elliptic shape (in such a shape, a ratio between a length in a major axis thereof and a length in a minor axis direction thereof is substantially identical with that of each of the microlenses 105a).

In the case where the microlenses 105a and the convex curved surfaces 105b have such shapes, it is possible to more reliably prevent contrast of the image from being reduced due to decrease of transmittance of the incident light.

Further, it is preferred that a top of each of the microlenses 105a (a center of each of the microlenses 105a in the planar view thereof) and a top of each of the convex curved surfaces 105b (a center of each of the convex curved surfaces 105b in a planar view thereof) overlap each other in the planar view of the microlens substrate 105.

In the case where the microlenses 105a and the convex curved surfaces 105b are provided in such a manner, it is possible to more reliably prevent the contrast of the image from being reduced due to decrease of the transmittance of the incident light.

A diameter of each of the convex curved surfaces 105b (in the case where each of the convex curved surfaces 105b has the elliptic shape, the length in the minor axis direction thereof) is preferably in the range of 3.3 to 25,000 μm, more preferably in the range of 10 to 5,000 μm, even more preferably in the range of 30 to 3,000 μm, and most preferably in the range of 40 to 2,000 μm.

By setting the diameter of each of the convex curved surfaces 105b to the above range, it is possible to efficiently prevent the transmittance of the incident light from being decreased and to efficiently reflect diffusely the light entered from the light emission side surface of the microlens substrate 105. As a result, it is possible to obtain an image having especially excellent contrast.

In this regard, in the microlens substrate 105, a pitch between the convex curved surfaces 105b which are adjacent together is preferably in the range of 3.3 to 25,000 μm, more preferably in the range of 10 to 500 μm, even more preferably in the range of 30 to 300 μm, and most preferably in the range of 50 to 100 μm.

Further, a curvature radius of each of the convex curved surfaces 105b (in the case where each of the convex curved surfaces 105b has the elliptic shape, a curvature radius in the minor axis direction thereof) is preferably is preferably in the range of 15 to 2,500 μm, more preferably in the range of 18 to 1,500 μm, and even more preferably in the range of 20 to 750 μm.

By setting the curvature radius of each of the convex curved surfaces 105b to the above range, it is possible to efficiently prevent the transmittance of the incident light from being decreased and to efficiently reflect diffusely the light entered from the light emission side surface of the microlens substrate 105. As a result, it is possible to obtain an image having especially excellent contrast.

Further, in the case where the curvature radius of each of the convex curved surfaces 105b is defined as R₂ (μm) and the curvature radius of each of the microlenses 105a is defined as R₁ (μm), the R₁ and R₂ preferably satisfy a relation of 3≦R₂/R₁≦100, more preferably satisfy a relation of 5≦R₂/R₁≦50, even more preferably satisfy a relation of 8≦R₂/R₁≦25, and most preferably satisfy a relation of 10≦R₂/R₁≦20.

In the case where the R₁ and R₂ satisfy the above relation, it is possible to efficiently prevent the transmittance of the incident light from being decreased and to efficiently reflect diffusely the light entered from the light emission side surface of the microlens substrate 105. As a result, it is possible to obtain an image having especially excellent contrast.

Furthermore, an arrangement pattern of the convex curved surfaces 105b is not particularly limited to a specific type. The arrangement pattern may be either an arrangement pattern in which the convex curved surfaces 105b are arranged in a regular manner (for example, a lattice-shaped manner, a honeycomb-shaped manner, a houndstooth check manner) or an arrangement pattern in which the convex curved surfaces 105b are arranged in an optically random manner (the convex curved surfaces 105b are randomly arranged with each other in the planer view from the major surface of the microlens substrate 105).

However, it is preferred that the arrangement pattern of the convex curved surfaces 105b corresponds to that of the microlenses 105a. This makes it possible to more reliably prevent the contrast of the image from being reduced due to the decrease of transmittance of the incident light.

Further, a ratio of an area (a projected area) occupied by all the convex curved surfaces 105b in the usable area where the microlenses 105a are formed with respect to the entire usable area is preferably 50% or more, more preferably 90% or more, and even more preferably 96% or more when the microlens substrate 105 is viewed from the light incident side thereof (or the light emission side thereof).

In the case where the ratio of the area occupied by all the convex curved surfaces 105b in the usable area with respect to the entire usable area is 50% or more, it is possible to more reliably prevent the contrast of the image from being reduced due to reflection of the outside light.

In addition, the microlens substrate 105 may include a shading portion (a black matrix) which is not shown. This makes it possible to obtain an image having more excellent contrast.

The Fresnel lens portion 102 is bonded to the light incident side surface of the substrate with concave portions 103 of the microlens portion 101 having such a configuration. The Fresnel lens portion 102 is arranged on the side of the light (image light) incident surface of the microlens substrate 105 the light that has been transmitted by the Fresnel lens portion 102 enters the microlens substrate 105.

The Fresnel lens portion 102 is provided with a plurality of prisms that are formed on a light emission surface thereof in a substantially concentric manner. This Fresnel lens portion 102 is bonded to the light incident side surface of the substrate with concave portions 103 through a bonding film 107.

The Fresnel lens portion 102 deflects the image light projected from the projection lens (not shown) and outputs the parallel light La that is parallel to a perpendicular direction of the major surface of the microlens substrate 105.

In the transmission screen 100 constructed as described above, the image light from the projection lens is deflected by the Fresnel lens portion 102 to become the parallel light La. The parallel light La is condensed by the respective microlens 105a, is focused, and then is diffused.

Rear-type Projector

Hereinafter, a description will be made on a rear-type projector provided with the transmission screen 100 described above.

FIG. 9 is a view schematically showing the rear-type projector provided with the transmission screen shown in FIG. 8.

As shown in FIG. 9, the rear projection 300 has a structure in which a projection optical unit 310, a light guiding mirror 320 and a transmission screen 100 are arranged in a casing 340.

Since the rear-type projector 300 is provided with the above mentioned transmission screen 100, it is possible to obtain an image having excellent contrast. In addition, since the rear-type projector 300 has the structure as described above in this embodiment, it is possible to obtain excellent angle of view characteristics and light use efficiency, in particular.

Hereinabove, although the transmission screen, in which the bonded body of the present invention is used, has been described, the bonded body of the present invention may be used as components constituting the liquid crystal light valve of a projection display device (a front projector).

Further, in this embodiment, the description is made on the case that the gap members 105d each having the refractive index nearly equal to that of the silicone portion 105c are used.

However, in the case where the gap members 105d are substantially located in regions (non-effective lens regions) in which the concave portions are not formed in the substrate with concave portions 103 and the substrate with concave portions 104, each of the gap members 105d may have a refractive index different from that of the silicone portion 105c.

Further, although in the above embodiment, the description is made on the case that the microlens substrate 105 has the convex curved surfaces 105b as the portions that prevent the total reflection of the light, the convex curved surfaces 105b may be omitted.

Furthermore, although in the above embodiment, the description is made on the case that the transmission screen includes the microlens portion and the Fresnel lens portion, the transmission screen may not include the Fresnel lens portion necessarily.

Moreover, although in the above embodiment, the description is made on the case that the lens substrate is provided with the microlenses as the lens portions, the lens portions (lenses) are not limited thereto, but may be formed from lenticular lenses.

Although the bonded body and the method of manufacturing the bonded body according to the present invention has been described above based on the embodiments illustrated in the drawings, the present invention is not limited thereto. If necessary, one or more arbitrary component may be added in the bonded body according to the present invention. Further, if necessary, one or more arbitrary step may be added in the method of manufacturing the bonded body according to the present invention.

It is needless to say that the bonded body according to the present invention can be used in other apparatuses than the liquid droplet ejection dead and the transmission screen as described in the embodiments. Examples of the other apparatuses include a semiconductor apparatus, a MEMS, a microreactor and the like.

Further, although in the above embodiment, the silicone portion 31 is formed so as to closely fill between the gap members 32, regions where the silicone portion 31 is not formed between the gap members 32 may exist. In this case, the amount of the silicone material contained in the liquid material has only to be reduced.

### EXAMPLES

Next, description will be made on a number of concrete examples of the present invention.

### Example 1

First, a monocrystalline silicon substrate having a length of 20 mm, a width of 20 mm and an average thickness of 1 mm was prepared as a first base member. A quartz glass substrate having a length of 20 mm, a width of 20 mm and an average thickness of 1 mm was prepared as a second base member. Both the monocrystalline silicon substrate and the quartz glass substrate were subjected to a surface treatment using oxygen plasma.

Next, a liquid having a viscosity of 18.0 mPa·s at 25° C. (“KR-251” produced by Shin-Etsu Chemical Co., Ltd.) was prepared. In this regard, the liquid material contained a silicone material composed of silicone compounds each having a polydimethylsiloxane chemical structure, and toluene and isobutanol as a solvent.

On the other hand, silica particles (ceramics particles) each having a spherical shape and an average particle size of 10 μm as gap members. 100 g of the liquid and 1 g of the gap members were mixed with each other to obtain a liquid material.

Then, the liquid material was ejected in the form of liquid droplets each having a volume of 5 μL onto a surface of the monocrystalline silicon substrate using an ink jet method, to form a liquid coating.

Next, the monocrystalline silicon substrate and the quartz glass substrate were laminated together through the liquid coating. Then, the liquid coating was dried at 100° C. for 30 minutes, to thereby obtain a bonding film having an average thickness of about 10 μm.

Then, an ultraviolet ray was irradiated on the bonding film through the monocrystalline silicon substrate under the following conditions.

Ultraviolet Ray Irradiation Conditions
Composition of atmospheric gas: air atmosphere
Temperature of atmospheric gas: 20° C.
Pressure of atmospheric gas: atmospheric pressure (100 kPa)
Wavelength of ultraviolet ray: 172 nm
Irradiation time of ultraviolet ray: 5 minutes

At this time, the monocrystalline silicon substrate and the quartz glass substrate were heated at a temperature of 80° C. while compressing the same under a pressure of 3 MPa and were maintained for 15 minutes.

In this way, obtained was a bonded body (a laminated body) in which the monocrystalline silicon substrate and the quartz glass substrate were bonded together through the bonding film.

A difference between a maximum thickness of the bonded body and a minimum thickness thereof (a variation of the thickness of the bonded body) was 0.8 μm.

In this regard, bonding strength between the monocrystalline silicon substrate and the glass substrate was measured using a mechanical strength tester (“ROMULUS” produced by QUAD GROUP Inc.). As a result, the bonding strength was 10 MPa or more.

Thereafter, an ultraviolet ray was irradiated on the bonding film of the bonded body under the following conditions. As a result, the quartz glass substrate could be peeled off from the monocrystalline silicon substrate.

Ultraviolet Ray Irradiation Conditions
Composition of atmospheric gas: N₂ gas
Temperature of atmospheric gas: 20° C.
Pressure of atmospheric gas: atmospheric pressure (100 kPa)
Wavelength of ultraviolet ray: 172 nm
Irradiation time of ultraviolet ray: 30 minutes

### Example 2

A bonded body was manufactured in the same manner as in the Example 1, except that resin particles each formed of polyethylene were used as the gap members instead of the silica particles.

Like in the Example 1, in this Example 2, the formed bonding film had an average thickness of about 10 μm. Further, bonding strength between the monocrystalline silicon substrate and the quartz glass substrate was 10 MPa or more.

A difference between a maximum thickness of the bonded body and a minimum thickness thereof (a variation of the thickness of the bonded body) was 1.0 μm.

Thereafter, an ultraviolet ray was irradiated on the bonding film of the bonded body. As a result, the quartz glass substrate could be peeled off from the monocrystalline silicon substrate. Especially, in this Example 2, the quartz glass substrate could be peeled off from the monocrystalline silicon substrate in a time shorter than that of the Example 1.

### Example 3

A bonded body was manufactured in the same manner as in the Example 1, except that metal particles each formed of Copper were used as the gap members instead of the silica particles.

Like in the Example 1, in this Example 3, the formed bonding film had an average thickness of about 10 μm. Further, bonding strength between the monocrystalline silicon substrate and the quartz glass substrate was 10 MPa or more.

A difference between a maximum thickness of the bonded body and a minimum thickness thereof (a variation of the thickness of the bonded body) was 0.8 μm.

Thereafter, an ultraviolet ray was irradiated on the bonding film of the bonded body. As a result, the quartz glass substrate could be peeled off from the monocrystalline silicon substrate. Especially, in this Example 3, the quartz glass substrate could be peeled off from the monocrystalline silicon substrate in a time longer than that of the Example 2, but shorter than that of the Example 1.

### Example 4

A bonded body was manufactured in the same manner as in the Example 1, except that resin particles each formed of polyethylene were used as the gap members in addition to the silica particles.

Here, 100 g of the above liquid having a viscosity of 18.0 mPa·s at 25° C. (“KR-251” produced by Shin-Etsu Chemical Co., Ltd.), 1 g of the silica particles and 0.5 g of the resin particles were mixed with each other to obtain a liquid material.

Further, an average particle size of the silica particles was 10 μm and an average particle size of the resin particles was 12 μm.

Like in the Example 1, in this Example 4, the formed bonding film had an average thickness of about 10 μm. Further, bonding strength between the monocrystalline silicon substrate and the quartz glass substrate was 10 MPa or more.

A difference between a maximum thickness of the bonded body and a minimum thickness thereof (a variation of the thickness of the bonded body) was 0.9 μm.

Thereafter, an ultraviolet ray was irradiated on the bonding film of the bonded body. As a result, the quartz glass substrate could be peeled off from the monocrystalline silicon substrate. Especially, in this Example 4, the quartz glass substrate could be peeled off from the monocrystalline silicon substrate in a time shorter than that of the Example 1.

### Example 5

A bonded body was manufactured in the same manner as in the Example 3, except that resin particles each formed of polyethylene were used as the gap members in addition to the metal particles.

Here, 100 g of the above liquid having a viscosity of 18.0 mPa·s at 25° C. (“KR-251” produced by Shin-Etsu Chemical Co., Ltd.), 1 g of the metal particles and 0.5 g of the resin particles were mixed with each other to obtain a liquid material.

Further, an average particle size of the metal particles was 10 μm and an average particle size of the resin particles was 8 μm.

Like in the Example 1, in this Example 5, the formed bonding film had an average thickness of about 10 μm. Further, bonding strength between the monocrystalline silicon substrate and the quartz glass substrate was 10 MPa or more.

A difference between a maximum thickness of the bonded body and a minimum thickness thereof (a variation of the thickness of the bonded body) was 0.8 μm.

Thereafter, an ultraviolet ray was irradiated on the bonding film of the bonded body. As a result, the quartz glass substrate could be peeled off from the monocrystalline silicon substrate. Especially, in this Example 5, the quartz glass substrate could be peeled off from the monocrystalline silicon substrate in a time longer than that of the Example 4, but shorter than that of the Example 2.

What is claimed is:

1. A bonded body, comprising:
a first base member having a first bonding surface;
a second base member having a second bonding surface; and
a bonding film through which the first base member and the second base member are boded together, the bonding film having two surfaces each making contact with the first bonding surface and the second bonding surface, the bonding film including a silicone portion containing a silicone material composed of silicone compounds and a plurality of gap members that regulate a distance between the first base member and the second base member, at least a part of the gap members provided in the silicone portion,
wherein energy for bonding is applied to a region of at least a part of the bonding film to develop a bonding property in a vicinity of each of the surfaces of the bonding film corresponding to the region so that the first base member and the second base member are bonded together through the bonding film due to the bonding property.

2. The bonded body as claimed in claim 1, wherein each of the gap members has a particle shape.

3. The bonded body as claimed in claim 2, wherein the plurality of the gap members include a plurality of glass fine particles each formed of a glass material as a major component thereof.

4. The bonded body as claimed in claim 2, wherein the plurality of the gap members include a plurality of ceramics fine particles each formed of a ceramics material as a major component thereof.

5. The bonded body as claimed in claim 2, wherein the plurality of the gap members include a plurality of metal fine particles each formed of a metal material as a major component thereof.

6. The bonded body as claimed in claim 2, wherein the plurality of the gap members include a plurality of resin fine particles each formed of a resin material as a major component thereof.

7. The bonded body as claimed in claim 6, wherein the plurality of the gap members include a plurality of fine particles composed of at least one kind selected from the group comprising a plurality of glass fine particles each formed of a glass material as a major component thereof, a plurality of ceramics fine particles each formed of a ceramics material as a major component thereof and a plurality of metal fine particles each formed of a metal material as a major component thereof, in addition to the plurality of the resin fine particles, and
wherein an average particle size of the plurality of the fine particles is larger than an average particle size of the plurality of the resin fine particles.

8. The bonded body as claimed in claim 6, wherein the plurality of the gap members include a plurality of fine particles composed of at least one kind selected from the group comprising a plurality of glass fine particles each formed of a glass material as a major component thereof, a plurality of ceramics fine particles each formed of a ceramics material as a major component thereof and a plurality of metal fine particles each formed of a metal material as a major component thereof, in addition to the plurality of the resin fine particles, and
wherein an average particle size of the plurality of the fine particles is smaller than an average particle size of the plurality of the resin fine particles, and the resin fine particles exist within the bonding film in a state that at least a part of the resin fine particles is elastically deformed.

9. The bonded body as claimed in claim 1, wherein each of the first bonding surface and the second bonding surface forms a flat surface.

10. The bonded body as claimed in claim 1, wherein the bonding film is configured so that the bonded body can be separated into the first base member and the second base member by applying energy for separation to the bonding film whereby cleavage is generated within the bonding film due to breakage of a part of molecular bonds of the silicone compounds.

11. The bonded body as claimed in claim 10, wherein the bonding film is configured to generate the cleavage therewithin by at least one method selected from the group comprising a method in which an energy beam is irradiated on the bonding film and a method in which the bonding film is heated.

12. The bonded body as claimed in claim 11, wherein the energy beam is an ultraviolet ray.

13. The bonded body as claimed in claim 12, wherein at least one of the first base member and the second base member has permeability for the ultraviolet ray.

14. The bonded body as claimed in claim 11, wherein a temperature of the heating is in the range of 100 to 400° C.

15. The bonded body as claimed in claim 10, wherein the bonding film is configured to generate the cleavage therewithin by applying the energy for separation to the bonding film in an air atmosphere.

16. The bonded body as claimed in claim 1, wherein each of the silicone compounds has a polydimethylsiloxane chemical structure as a main chemical structure thereof.

17. The bonded body as claimed in claim 1, wherein each of the silicone compounds has at least one silanol group.

18. The bonded body as claimed in claim 1, wherein an average thickness of the bonding film is in the range of 1 to 300 μm.

19. A method of manufacturing a bonded body in which a first base member and a second base member are bonded together through a bonding film having a predetermined pattern, the method comprising:
applying a liquid material containing a silicone material composed of silicone compounds and a plurality of gap members onto a surface of at least one of the first base member and the second base member to form a liquid coating having a pattern corresponding to the predetermined pattern of the bonding film on the surface;
laminating the first base member and the second base member together through the liquid coating so as to regulate a distance between the first base member and the second base member by the gap members;
drying the liquid coating while maintaining the distance between the first base member and the second base member by the gap members to obtain the bonding film having the predetermined pattern; and
applying energy for bonding to the bonding film to develop a bonding property in a vicinity of each of surfaces of the bonding film so that the first base member and the second base member are bonded together through the bonding film due to the bonding property.
